(19) United States
(12) Patent Application Publication
(10) Pub. No.: US 2003/0035138 A1
(43) Pub. Date: Feb. 20, 2003

(54) Internet-based custom package-printing process

(76) Inventor: Mary K. Schilling, Fountaintown, IN (US)

Correspondence Address: BARNES & THORNBURG, 11 SOUTH MERIDIAN, INDIANAPOLIS, IN, 46204

(21) Appl. No.: 10/217,275

(22) Filed: Aug. 12, 2002

Related U.S. Application Data
(60) Provisional application No. 60/313,073, filed on Aug. 17, 2001.

(51) Int. Cl. B41J 1/00; G06F 15/00; H04N 1/00

(52) U.S. Cl. 358/1.15; 358/402

(57) ABSTRACT

A process is provided to enable package customers to control package selection, design, shipping, and payment decisions via the Internet so that customized package orders may be placed and filled electronically.

This patent application claims priority under 35 U.S.C. §119(e) to U.S. Provisional Patent Application Serial No. 60/313,073, filed Aug. 17, 2001, the disclosure of which is hereby incorporated by reference herein.

### BACKGROUND AND SUMMARY

This disclosure relates to printing processes and particularly to processes for printing images on packaging materials. More particularly, this disclosure relates to a process for printing customized images on packages in relatively low order quantities.

Manufacturers of packaging materials sometimes print text and graphical images on packaging materials in accordance with design specifications provided by their customers. Some conventional custom printing processes, such as flexographic processes, require that printing plates be made or that Mylar film be developed. The plates or film are mounted on cylinders that, in turn, are installed in a printing press. In order to change from one custom printing job to another, these conventional printing presses are shut down so that the cylinders can be changed. Cylinder change over times are typically one to three hours.

When manufacturing runs are large, such as on the order of 10,000 units or 100,000 units or more, the costs associated with plate or film development and printing press down time for cylinder change over does not impact significantly the piece price of custom printed packaging materials. However, some customers, such as small businesses, prefer to order packaging materials having customized images in relatively low order quantities. Order quantities of 1000, 500, 100, or even less are not uncommon for small businesses. Using conventional printing techniques, the piece price for packages with custom printing at these low quantities is quite high and in some instances, cost prohibitive. Other types of overhead, such as customer service, order entry, material handling, material tracking, billing, collection, and the like are also considered by manufacturers when establishing piece price for packaging materials having customized images.

According to the present disclosure, a process is provided to enable package customers to control package selection, design, shipping, and payment decisions via the Internet so that customized package orders may be placed and filled electronically. By receiving customized package orders electronically and by printing graphics on the packaging materials using digital printing techniques, instead of using printing machines requiring cylinders with plates or film, the costs to produce customized packages at low order quantities is reduced significantly. In an illustrative embodiment, a computer-controlled, high speed press having multiple non-impact, ink jet print heads is used to print graphics on the packaging materials.

In illustrative embodiments, a web site is accessible by a customer via the Internet and is configured to comprise one or more of an order/reorder transaction web page, a package size web page, a substrate web page, a quantity web page, an artwork web page comprising a text system and an image system, an order confirmation web page, and a reorder confirmation web page. Also in illustrative embodiments, the text and image systems comprise a process to enable online customers to “customize” their packages by (1) adding graphics (i.e. text and images), including numerous images available in an art library or by (2) uploading their own text and images to build a customer-defined “text and image” library and adding artwork from that customer-defined library. In one embodiment, once a customized package order is placed by a customer, that order (or re-order) is communicated via the Internet to a package printing site where packages are printed to the custom specifications ordered by the customer, a financial account established by the customer is charged for the order, and the completed and paid for order is shipped to the customer.

According to this disclosure, order data received from a customer via the Internet is processed electronically to create various data files, one of which controls the set up of the printing machine and another of which controls the operation of the print heads included in the printing machine. The data files are downloaded to a computer that operates the printing machine and are stored in an Orders directory. When an operator selects a job to be run from the Orders directory, the printing machine is automatically configured for the job. After the appropriate packaging is loaded onto the printing machine (also referred to herein as a “press” or “printing press”), the operator simply activates the printing machine which then automatically runs the packaging materials through the machine and automatically prints the custom graphics on the packaging materials. After one job is finished, the operator simply selects the next job to be run from the order directory and the printing machine is automatically configured for the next job.

Additional features will become apparent to those skilled in the art upon consideration of the following detailed description of illustrative embodiments exemplifying the best mode of carrying out the Internet-based custom package-printing process as presently perceived.

### BRIEF DESCRIPTION OF THE DRAWINGS

The detailed description particularly refers to the accompanying figures, in which:

FIG. 1 is a diagrammatic view of a custom package-printing system according to this disclosure showing a web server coupled to the Internet, three remote computers coupled to the Internet, and a package printing device coupled to the web server via a series of intermediate computer devices;

FIGS. 2A and 2B cooperate to create a diagrammatic view showing a broad overview of a process for receiving, processing, fulfilling, and managing custom package-printing orders;

FIGS. 3A, 3B, 3C, 3D, 3E, and 3F cooperate to create a flow chart illustrating, in more detail, the process for receiving, processing, fulfilling, and managing custom package-printing orders;

FIG. 4 is a flow diagram showing the interrelationship between pages of a website that is accessed by a customer to place a custom package-printing order;

FIG. 5 is a screen printout of a Home page of the website;

FIG. 6 is a screen printout of a Login page of the website;

FIG. 7 is a screen printout of a first Box Selections page of the website;

FIG. 8 is a screen printout of a second Box Selections page of the website;

FIG. 9 is a screen printout of a first Buying Options page of the website;

FIG. 10 is a printout of a Print Area Selection window of the website showing a box in knock-down configuration and showing the areas on the box that are available for printing of custom graphics;

FIG. 11 is a printout of a first Selected Print Area window of the website showing which area of the box is selected to receive custom graphics;

FIG. 12 is printout of a first Art Library window of the website showing three different images stored in a Celestial folder of an art library;

FIG. 13 is a printout of a second Art Library window of the website showing the customer's selection of one of the images from the Celestial folder;

FIG. 14 is a printout of a first User's Private Art window of the website showing a set of images stored in a customer's individual folder of existing images;

FIG. 15 is a printout of a second User's Private Art window of the website showing the customer's selection of one of the images from the individual folder;

FIG. 16 is a printout of a second Selected Print Area window of the website showing the selected image of FIG. 15 in the selected area of the box;

FIG. 17 is a printout of the window of FIG. 16 showing the selected image moved to a desired location in the print area, the selected image being enlarged, a first pop-up menu indicating the available colors for printing the selected image, a string of text entered in a “text body” box, a text style box indicating a style of text, a text size box indicating a size of text, a second pop-up menu indicating the available text sizes, a text color box indicating a color of text, and a third pop-up menu indicating the available text colors;

FIG. 18 is a printout of the window of FIG. 17 showing the text added to the print area adjacent to the image and showing a Save & Preview button in the lower right comer of the window;

FIG. 19 is a printout of a Preview window that appears after the Save & Preview button of the window of FIG. 18 has been selected showing the box in the knock-down configuration with the custom graphics simulated in the selected print area;

FIG. 20 is a printout of a 3D window showing a rendering of the box in an assembled configuration with the custom graphics simulated in the selected print area;

FIG. 21 is a printout of a Box Name window that appears after a Save Design button is selected so that a name of the box design can be assigned by the customer;

FIG. 22 is a screen printout of a Cart page of the website showing a table with details about the custom package designed by the customer and showing a Quantity box in the table for entry of the quantity of custom boxes that the customer wants to order;

FIG. 23 is a screen printout of an Upload Images page of the website showing a Choose File window that appears after a Browse icon is selected;

FIG. 24 is a screen printout of an Existing Box Design page of the website showing a list of past designs on a table and showing Delete, View & Edit, and Buy icons on the table;

FIG. 25 is a screen printout of a Ship-to Address page of the website;

FIG. 26 is a screen printout of an Add New Shipping Address page of the website;

FIG. 27 is a screen printout of an Order Summary page of the website;

FIG. 28 is a screen printout of a Credit Card page of the website;

FIG. 29 is a screen printout of an Order Confirmation page of the website;

FIG. 30 is a screen printout of an Order Details page of the website;

FIG. 31 is a screen printout of an Order History page of the website; and

FIG. 32 is a flow diagram showing order data received via the website being processed into a first set of files by a web server, the first set of files being transferred to a printque server for additional processing, and the files from the printque server being retrievable by a press computer.

### DETAILED DESCRIPTION OF THE DRAWINGS

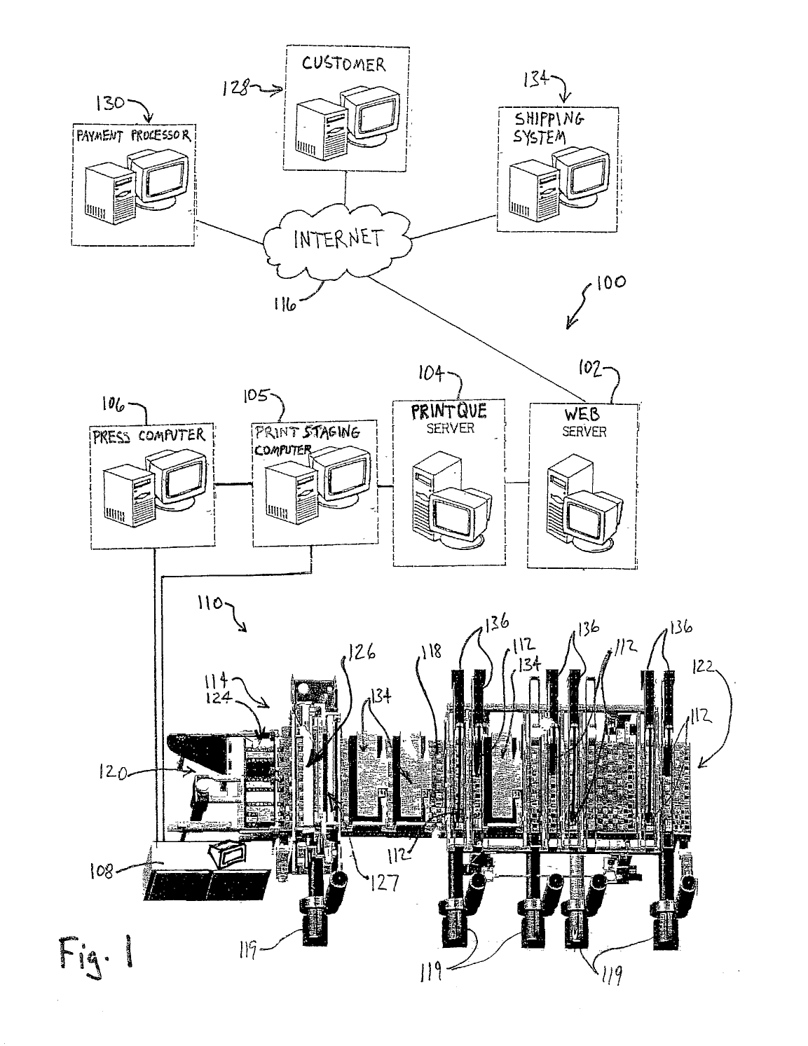

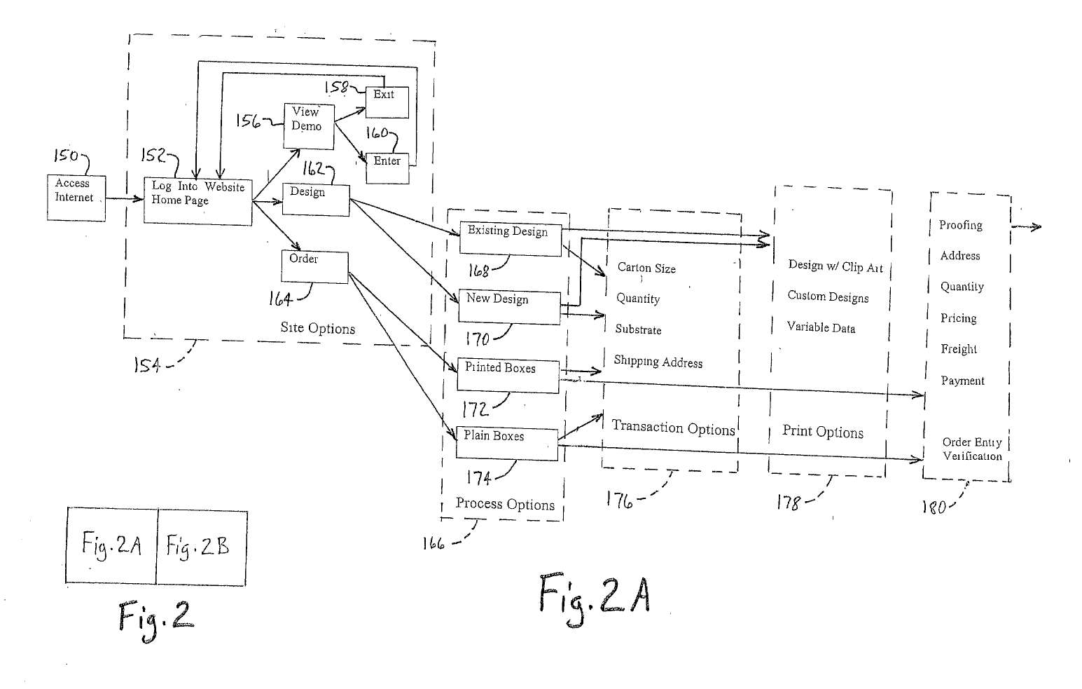

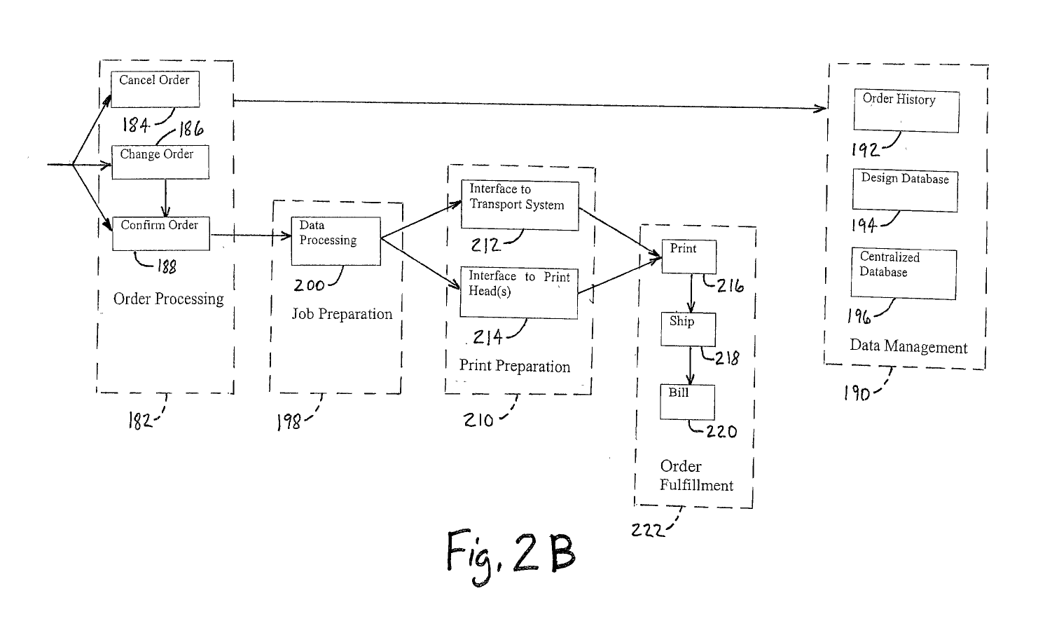

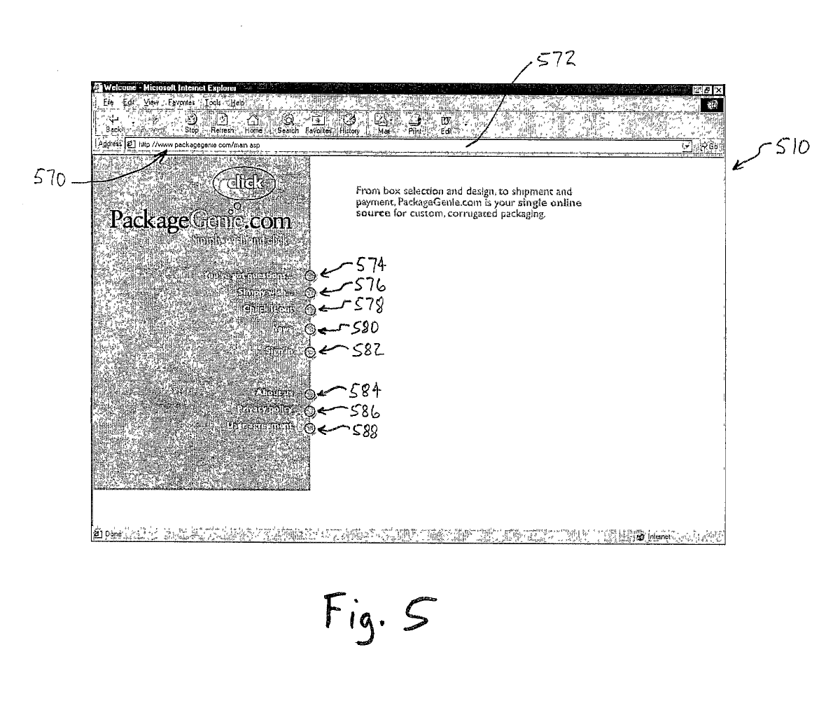

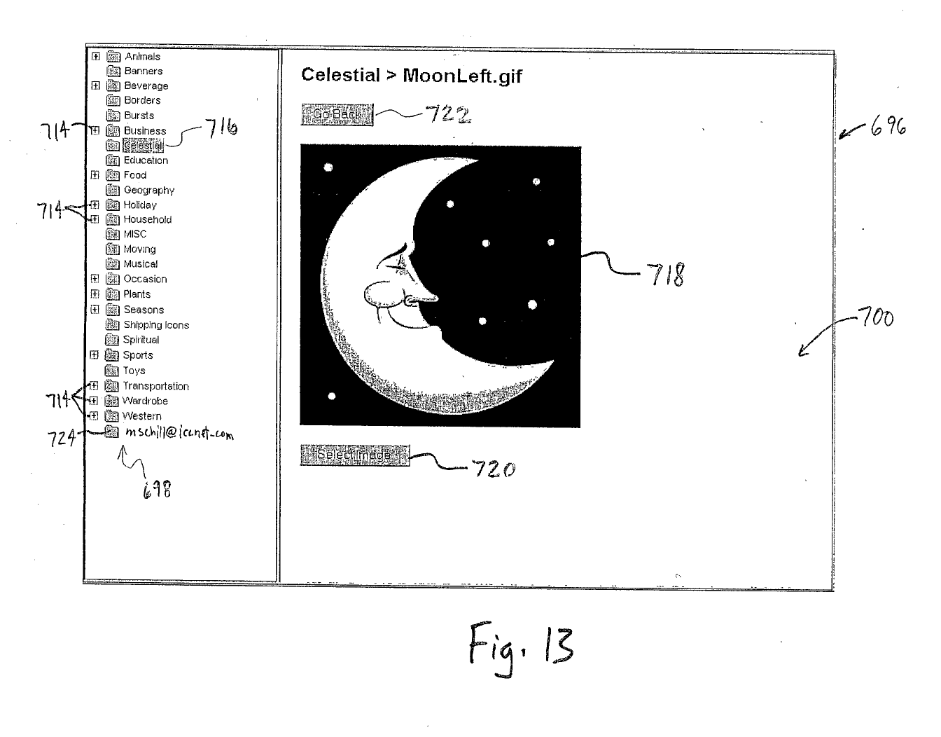

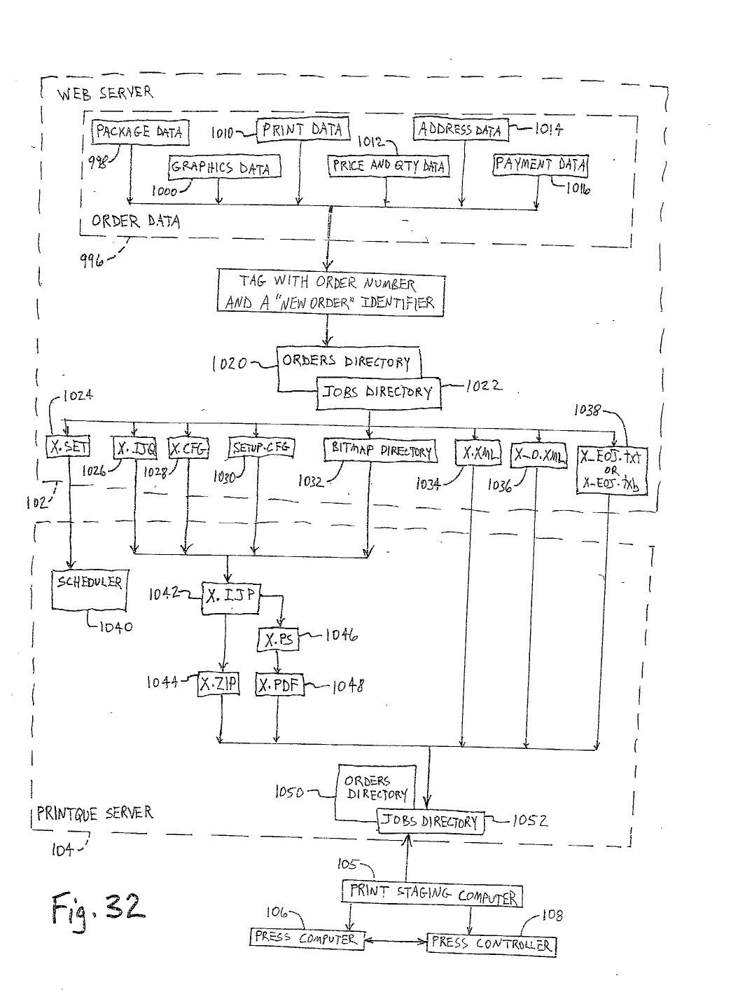

Illustrative embodiments of a method and apparatus for printing images on packaging materials are herein described. A custom package-printing system or apparatus is shown diagrammatically in FIG. 1. Flowcharts of the custom package-printing process and flowcharts of a website accessed by customers to place custom package-printing orders are shown in varying levels of detail in FIGS. 2-4. Although different types and amounts of detail are shown in each of the flowcharts, the flowcharts of FIGS. 2-4 generally relate to the same custom package-printing process. Web pages of a website used by customers to place custom package-printing orders are shown in FIGS. 5-31. A block diagram showing how order data is processed into various files is shown in FIG. 32.

The illustrative method of printing images on packaging materials comprises three high level operations. First, a customer order is received via the website. Second, the customer order is processed and translated into machine readable and human readable instructions for processing packaging materials. Third, a packaging material press operator operates a packaging material printing press to print custom images on packaging materials, where the packaging material printing press has received the machine readable instructions, and the packaging material press operator has read the human readable instructions. Each of these steps is described in greater detail herein. After the packaging materials have had the custom images printed thereon, the packaging materials are shipped to the customer and the customer is billed for the order.

One embodiment of a system 100 for printing images on packaging materials in accordance with this disclosure is shown diagrammatically in FIG. 1. System 100 is well suited for custom package-printing orders of small order quantities. However, system 100 also may be used for package-printing orders of large order quantities. Illustratively, system 100 includes a first server 102, a second server 104, a print staging computer 105, a press computer 106, a press controller 108, and a printing machine or press 110 as shown diagrammatically in FIG. 1. Press 110 includes one or more print heads 112 and a transport system 114. Server 102 is coupled to the Internet 116 (also known as the “world wide web”) and is configured to host a website that is accessible via the Internet 116.

Server 102 is sometimes referred to herein as the “web server” and server 104 is sometimes referred to herein as the “printque server.” In some embodiments, servers 102, 104 and computers 105, 106 are components of a larger network of computer devices. Thus, although illustrative system 100 has two servers 102, 104, it is within the scope of this disclosure for system 100 to have one or more additional servers (e.g. a PC-based server, a minicomputer, a midrange computer, a mainframe computer, and the like) that are networked together and to have additional computer devices (e.g. desktop or PC-based computers, workstations, and the like) coupled to the network. It is also within the scope of this disclosure for system 100 to have only a single server that performs the functions of servers 102, 104. Computers 105, 106 may each include a central processing unit (CPU), memory devices (e.g. RAM, ROM, cache memory, non-volatile memory, and the like), and one or more peripheral components (e.g. a display screen, a printer, a mouse, a keyboard, and the like). Servers 102, 104 may be similarly configured, albeit typically with greater processing performance and storage capacity, as is well known in the art. Other types of storage devices such as floppy or removable disk drives, a direct access storage device (DASD), a hard disk drive, a CD drive, a DVD drive, a tape drive, and the like may also be included in or associated with servers 102, 104 and computers 105, 106 for reading data stored on the corresponding type of data storage media (e.g. floppy disk, CD, DVD, tape, etc.).

In the illustrative embodiment, the website hosted by server 102 is accessible by customers to place custom package-printing orders. Server 102 is also configured with software that initially processes the order data received via the website to ready the order data for transmission to the second server 104. Server 104 is configured with software that further processes the order data into a final machine-readable format that is read by controller 108 to control the physical location of print heads 112 and the operation of transport system 114 and that is read by computer 106 to control the manner in which print heads 112 print images on the packaging materials. In addition, server 104 is configured with software that processes the order data into a human-readable format, some of which is read by an operator on a screen of computer 106 and some of which is read by the operator on a screen of controller 108. Controller 108 is configured with user interface software that permits the operator to pull up a list of the orders that need to be fulfilled and to select jobs from each order that are to be run on press 110. Servers 102, 104 and computers 105, 106 are also configured with user interface software. In addition, servers 102, 104, computers 105, 106, and controller 108 are configured with other types of software, such as operating system software, web browser software, word processing software, and the like, as is well known in the art. Computer 106 is sometimes referred to herein as the “press computer” or the “operator computer.”

According to this disclosure, servers 102, 104 and computers 105, 106 may be situated at different locations, although computer 106 will generally be co-located with controller 108 and press 110. For example, server 102 may be located at corporate offices in one city, computer 104 may be located at a customer service center in another city, computer 105 may be located one room of a manufacturing facility in yet another city, and computer 106 may be located in another room of the manufacturing facility. It is also within the scope of this disclosure for servers 102, 104, computers 105, 106, controller 108, and press 110 to be located at a single facility. Thus, servers 102, 104, computers 105, 106, and controller 108 may be linked together by a local area network (LAN), a wide area network (WAN), a wireless network, the Internet 116, or any other type of network that permits data to be transmitted between servers 102, 104, computers 105, 106, and controller 108. In addition, it is within the scope of this disclosure for the functions of servers 102, 104, computers 105, 106, and controller 108 to be consolidated onto a lesser number of computer devices, such as a single computer device that performs all of the data handling and processing functions described herein.

System 100 interacts with other computer systems via the Internet 116. Illustratively, system 100 interacts via the Internet 116 with payment processing computer system 130 and shipping processing computer system 132. Payment processing system 130 includes one or more computers configured with payment processing software. Shipping processing system 132 includes one or more computers configured with shipping processing software. System 100 also interacts with customer computer system 128. Customer computer system 128 includes one or more computers configured with user interface software. Although, payment and shipping portions of the package-printing process of the illustrative embodiment are handled by third parties, as will be discussed in more detail below, it is within the scope of this disclosure for these processes to be handled within system 100. Thus, in alternative embodiments, payment processing system 130 and/or shipping processing system 132 are included in system 100.

In the illustrative embodiment, press 110 is a JETPAC™ printing press manufactured by United Container Machinery of Glen Arm, Md. and print heads 112 included in illustrative press 110 are manufactured by Scitex of Dayton, Ohio. Other types of presses 110 available from other manufacturers may be used in other embodiments of system 100 within the scope of this disclosure. Illustrative press 110 is configured to print on die-cut, knock down, or flat packaging materials, such as boxes. In other embodiments, press 110 is appropriately configured to print on packaging materials of other types, such as bottles, cans, or bags.

Transport system 114 of illustrative press 110 includes a vacuum table 118 that has a plurality of belt-driven rollers (not shown) which underlie the packaging materials and which are rotated to move packaging materials from a first end 120 of press 110 to a second end 122 of press 110. Table 118 has a plurality of vacuum blowers 119 that create suction through holes or gaps in the table to bias the packaging materials downwardly into contact with the rollers of table 118. In one embodiment, table 118 is 60 inches wide and has three 20 inch wide vacuums. The packaging materials are loaded onto a staging area 124 and a feeder 126 moves the packaging materials, one-by-one, from staging area 124 onto table 118. Table 118 moves the packaging materials beneath a coater 127, which applies a precoating dye fixative to the packaging materials, and then beneath one or more infrared dryers 134. Print speeds of 300 to 1,000 feet per minute (109.36 meters per minute to 365.53 meters per minute) have been achieved with transport system 114 of the illustrative press 110.

Illustrative print heads 112 are non-impact, ink jet print heads that are controlled digitally. Print heads 112 are spaced above the packaging materials by about 3/16 inch in one embodiment. In some embodiments, print heads 112 use environmentally friendly water-based inks that are safe for use with food packaging. Each print head 112 is mounted to a respective linear actuator 136. Each actuator 136 moves its associated print head 112 in a direction transverse to the direction of travel of the packaging materials from first end 120 to second end 122. Thus, depending upon the size of packaging materials being cycled through press 110, print heads 112 are moved by actuators 136 into the proper locations for printing graphics onto the packaging materials. In the illustrative embodiment, print heads 112 remain stationary while printing graphics onto the packaging materials.

Referring now to the block diagram of FIGS. 2A and 2B, a customer desiring to place a custom package-printing order accesses the Internet 116, as indicated at block 150, using customer computer system 128 and types a web address in the address bar appearing on the customer's computer screen to connect to the website hosted by server 102. Once the customer has accessed the website hosted by server 102, the user logs into the website Home page as indicated at block 152. Computer system 128 includes Internet browser software, such as, for example, NETSCAPE NAVIGATOR® software or INTERNET EXPLORER® software, that permits the customer to view the various web pages of the website and to enter package-order data. Once the customer has logged into the website, certain site options are available to the customer as indicated at block 154 of FIG. 2A.

If the customer is logging into the website for the first time or if a considerable amount of time has elapsed since the customer last logged into the website, the customer may wish to view a demonstration to learn how to use the website to place a custom printing order as indicated at block 156 in FIG. 2A. After the customer has viewed and closed the demonstration, the customer has the option from the Home page of exiting the website, as indicated at block 158, or entering back into the portion of the website that permits placement of custom package-printing orders, as indicated at block 160. After logging into the website at block 152 or after returning back into the site options 154 portion of the website at block 160, the customer has the choice of either navigating to the portion of the website that permits designing of the images to be printed on the packages, as indicated at block 162, or navigating to the portion of the website that permits order placement, as indicated at block 164.

After the customer chooses the design option of block 162 or the order option of bock 164, certain process options are available to the customer as indicated at block 166 of FIG. 2A. If the customer chooses the design option of block 162, the process options available to the customer at block 166 are to choose an existing design (i.e. a design that the customer has ordered in the past), as indicated at block 168, or to create a new design, as indicated at block 170. If the customer chooses the order option of block 164, the process options available to the customer at block 166 are to select printed boxes, as indicated at block 172, or to select plain boxes, as indicated at block 174. Although the apparatus and method for ordering packaging materials having custom graphics is described herein as relating to boxes, it is within the scope of this disclosure for the apparatus and method to be used for ordering other types of packaging materials, such as bottles, bags, cans, and the like. Thus, unless specifically noted otherwise, the terms “package” or “packaging materials” as used in this disclosure, including in the claims, is meant to cover packaging materials of every type.

After any one of the process options associated with blocks 168, 170, 172, 174 is selected, the customer is presented with various transaction options as indicated at block 176 of FIG. 2A. In the transaction options portion of the website, the customer selects such package order data as carton size/substrate, quantity, and shipping address as also indicated at block 176. If either of the process options associated with blocks 168, 170 are selected at block 166, the customer is also presented with various print options as indicated at block 178. In the print options portion of the website, the customer may create a design using clip art available on the website, create their own custom design, or provide variable data as also indicated at block 178. Regardless of the selections made by the customer at blocks 166, 176, 178, after making the desired selections, the customer enters into an order entry verification portion of the website as indicated at block 180. In the order entry verification portion of the website, the customer is able to proof the customer's package and graphics choices; to confirm address and quantity information; to review pricing; and to select freight and payment methods, as also indicated at block 180.

After completing the steps at the order entry verification portion of the website at block 180, the customer is presented with order processing options as indicated at block 182, shown in FIG. 2B. In the order processing options portion of the website, the customer is able to either cancel the order, as indicated at block 184; change the order, as indicated at block 186; or confirm the order, as indicated at block 188. As also indicated at block 182, if the customer changes the order at block 186, the customer is thereafter able to confirm the changed order at block 188. After an order is canceled at block 184, changed at block 186, and/or confirmed at block 188, certain data related to the order is stored in one or more databases resident in the memory of server 102 or in any other suitable memory device of system 100, for purposes of data management as indicated at block 190. For example, data pertaining to order history is stored in a database as indicated at block 192, data pertaining to the images and text that were selected or designed by the customer are stored in a design database as indicated at block 194, and other types of data associated with the order are stored in a centralized database as indicated at block 196.

The data stored in the databases associated with blocks 192, 194, 196 may be cataloged, assimilated, sorted or otherwise manipulated, as desired. For example, information about the total number of customers or total sales dollars in any particular geographic region, city, or zip code may be obtained by appropriately mining the data from the data bases associated with blocks 192, 194, 196. In addition, forecasts for the demand of various types and sizes of package materials may be obtained from the data in these data bases. Generalized accounting data, such as total sales to all customers, average quantity and/or price per order, number of orders canceled compared to number of confirmed, and the like may also be determined from the data stored in the data bases associated with blocks 192, 194, 196. With regard to block 194, design folders for each customer who uploads custom images and text to server 102 for placement on packages are stored so that when a particular customer logs onto the website at a later date, the individual design database associated with that particular customer is made available to the customer thereby preventing the customer from having to create the same design(s) or upload the same graphics again. With regard to block 192, the orders of each particular customer are saved in a database for retrieval at a later date so that, if the customer desires to place a re-order that matches a previous order, the customer does not need to provide all of the order data again.

After an order has been placed by a customer via the website, the order is prepared by servers 102, 104 and computer 106 for transmission to controller 108 of press 110 as indicated at job preparation block 198 of FIG. 2B. During job preparation, the order entry data is processed by software that is executed by servers 102, 104 to create the necessary files to run the jobs associated with the order as indicated at block 200. As part of the processing of order data at block 200, files are created and formatted appropriately by servers 102, 104 for retrieval by computer 106 and for transmission to press controller 108. Based on the files received from computer 106, controller 108 provides appropriate commands to control the configuration and operation of transport system 114, as indicated at “interface to transport system” block 212, and to control the location and operation of print head(s) 112, as indicated at “interface to print head(s)” block 214.

After press 110 is prepared for printing at block 210 by having the appropriate commands transmitted to controller 108 by computer 106, the custom package-printing order is ready to be fulfilled as indicated at block 222 of FIG. 2B. During order fulfillment, press 110 operates to print images and text on the packages in accordance with the custom package-printing order received via the Internet as indicated at print block 216. Once the graphics have been printed on the packaging materials, the packaging materials are shipped to the customer, as indicated at block 218 and the customer is billed, as indicated at block 220.

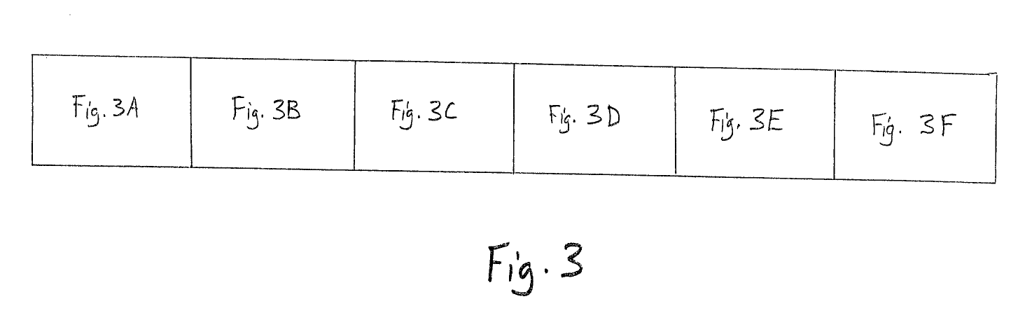

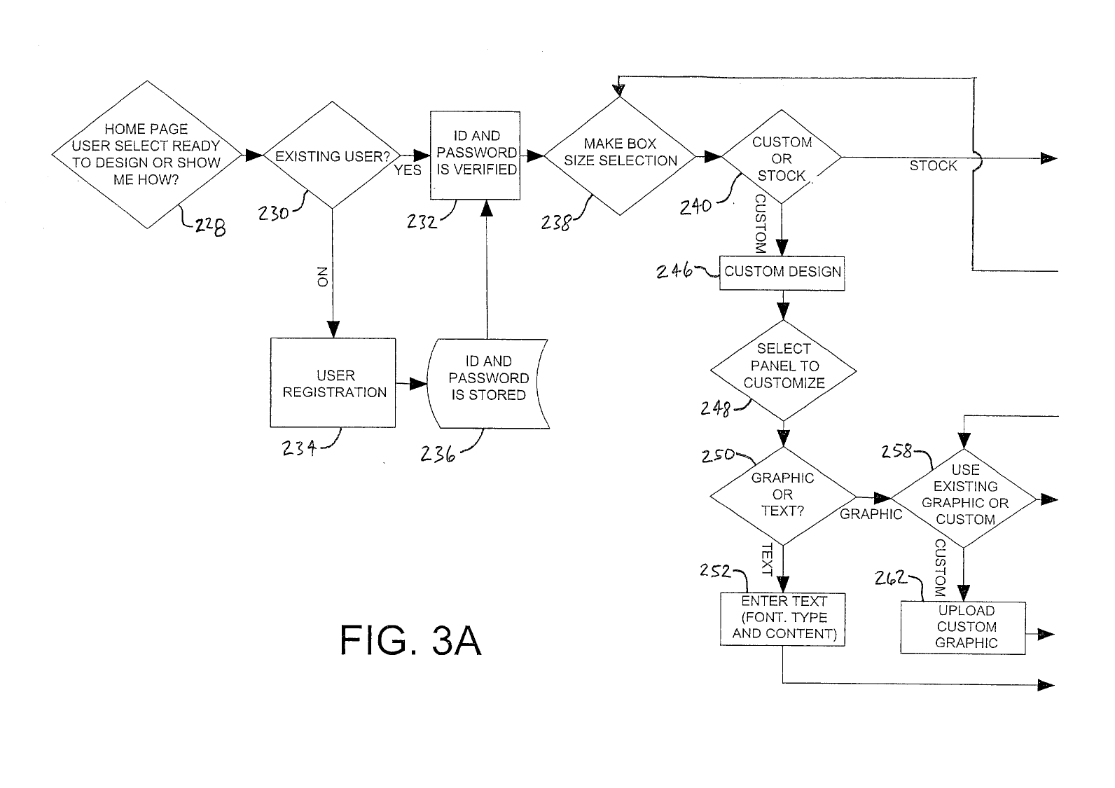

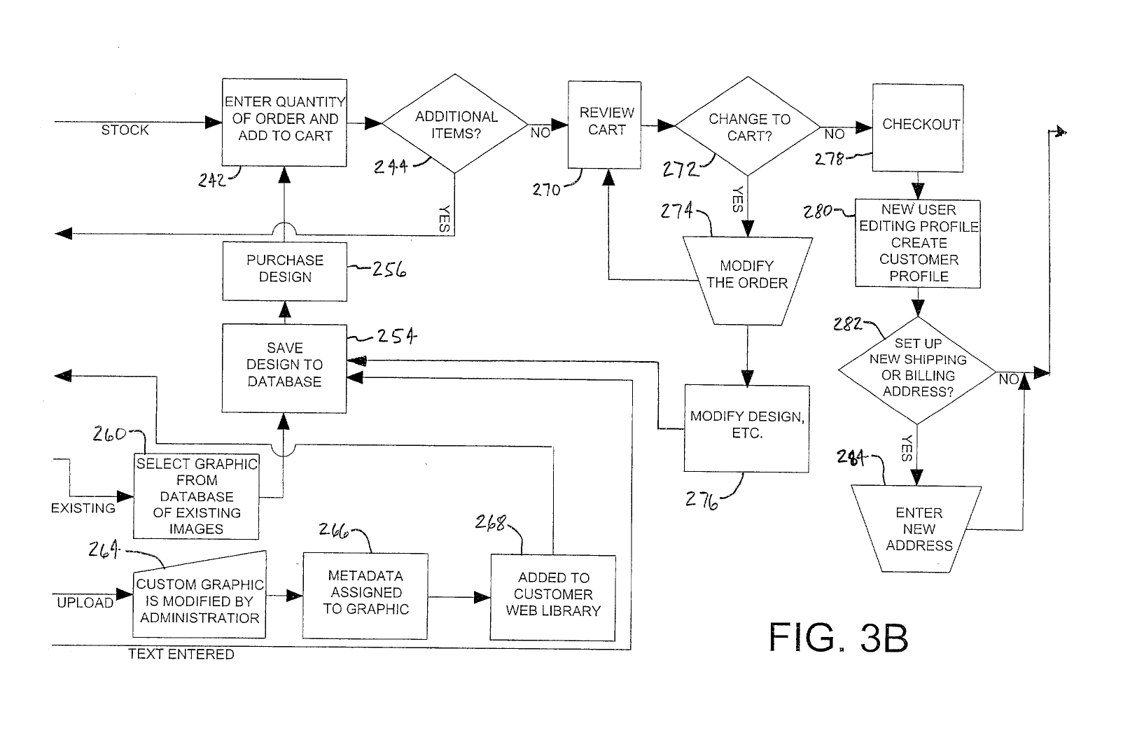

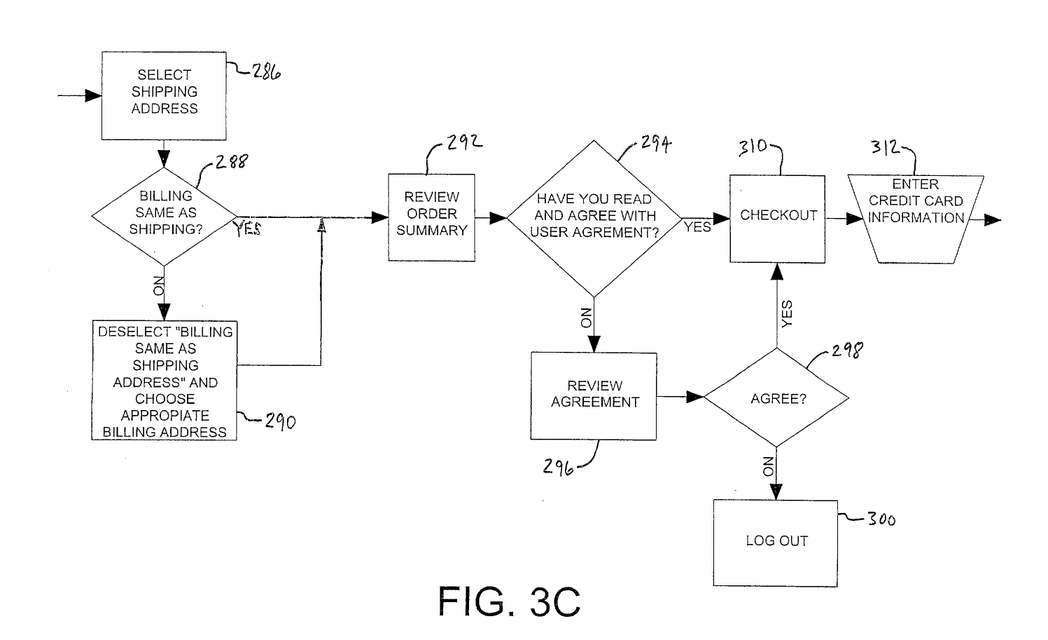

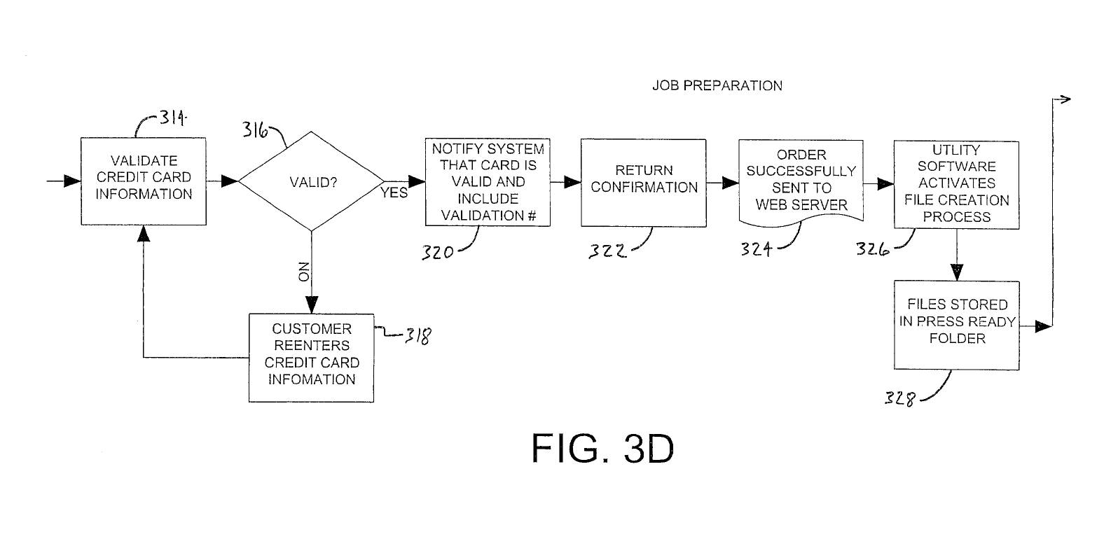

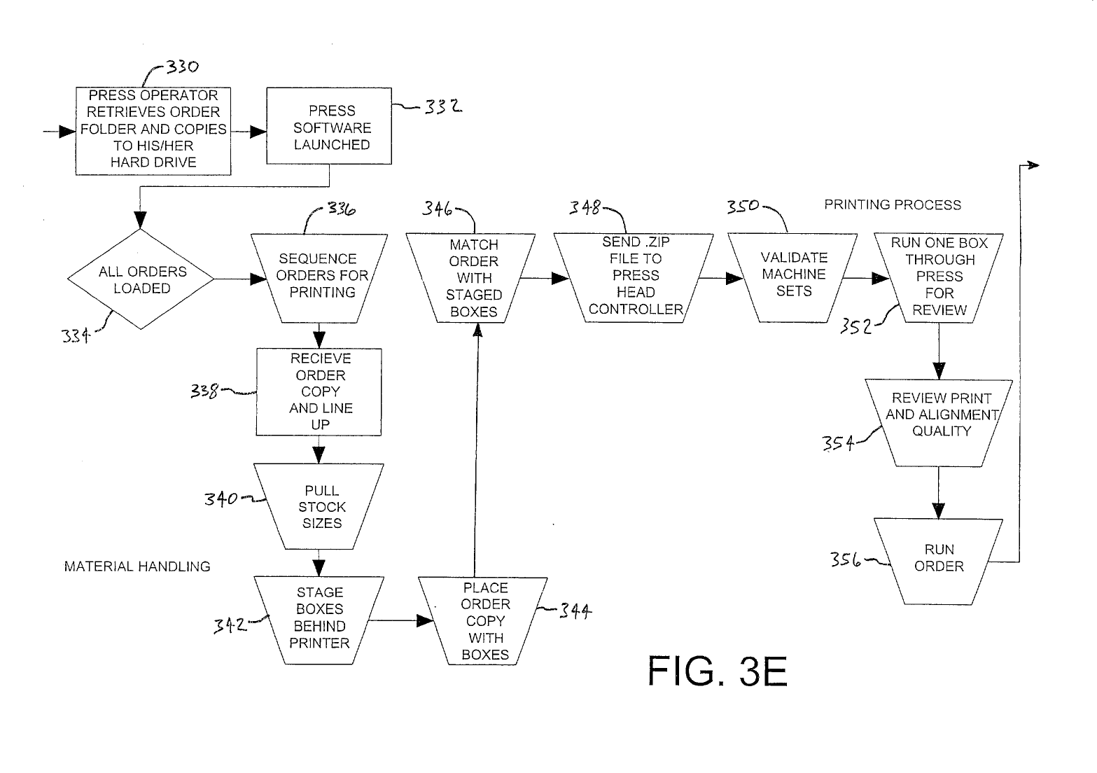

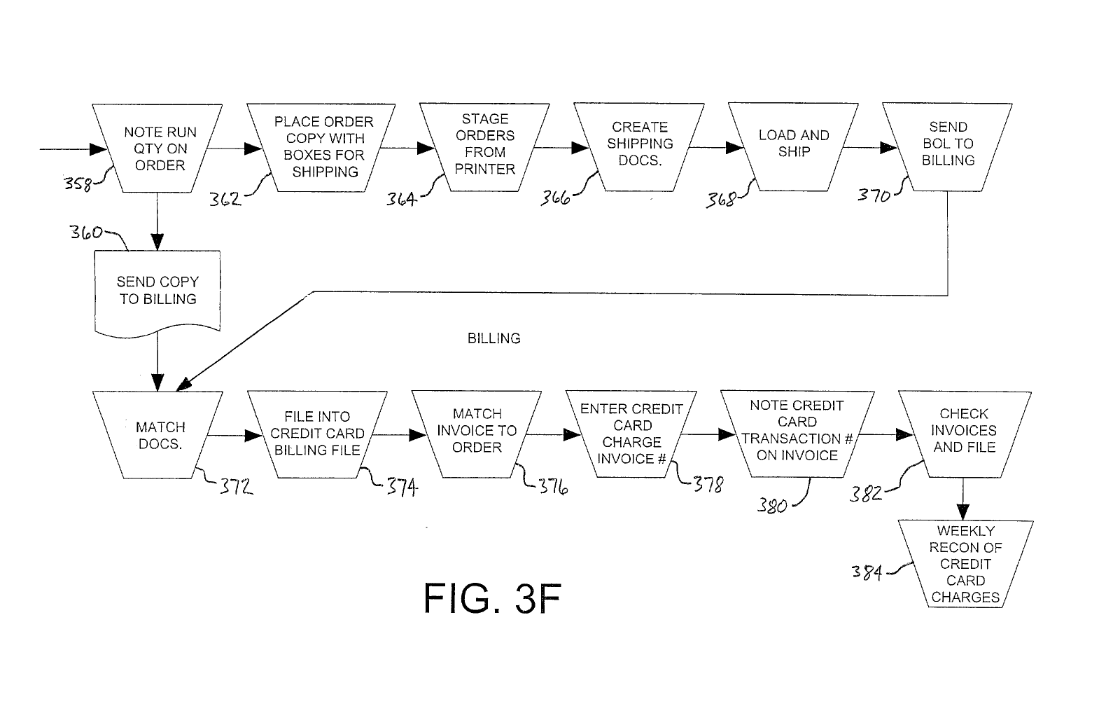

Referring now to FIGS. 3A-3F, a flow chart relating to placement of order for boxes with custom images printed thereon is illustrated. However, it is understood that in other embodiments according to this disclosure a similar process is used when placing orders for packages other than boxes.

When a customer logs onto the website to place a custom package-printing order, system 102 responds with a Home page at which the customer is able to indicate whether the user is ready to design a custom package or whether the user wants system 100 to execute a demonstration as indicated at block 228 of FIG. 3A. The Home page includes text or other suitable indicia to query the customer as to whether the customer is an “existing user” of system 100 as indicated at block 230. If the customer is an existing user, then the customer enters the customer's user ID and password and system 100 verifies that the customer has entered the proper user ID and password as indicated at block 232. If the customer is not an existing user, then the customer registers as a user as indicated at block 234. During the user registration process, system 102 stores the user ID and password entered by the customer as indicated at block 236.

After the customer has either registered as a new user or has entered the proper user IE) and password, the user makes a box size selection on the website as indicated at block 238. After the size of the box has been selected by the customer, the customer then uses the website to indicate whether the customer wants a custom design printed on the boxes or whether the customer simply wants stock (i.e. plain) boxes as indicated at block 240 in FIG. 3A. If the customer wants stock boxes, the customer uses the website to enter the desired quantity of stock boxes and to add the order to the customer's cart as indicated at block 242 in FIG. 3B. After completing the steps indicated at block 242, the customer indicates on the website whether or not the customer wants to order additional items as indicated at block 244. If the customer indicates at block 244 that additional items are to be ordered, then the customer is returned to block 238 as shown in FIGS. 3A and 3B.

After the customer makes the box size selection at block 238, if the customer indicates at block 240 that the customer wants a custom design printed on the boxes, then the customer will be linked to the portions of the website that permit custom designs to be created as indicated at block 246 in FIG. 3A. During the box design customization process, the customer selects the panel of the box (e.g. front panel, top panel, side panel, etc.) to be customized as indicated at block 248 and then the customer selects whether the customization will include a custom graphic or custom text as indicated at block 250. If the customer decides at block 250 that the custom design will include custom text, then the customer uses the website to enter the desired text to be included in the custom design, as indicated at block 252 in FIG. 3A. After the desired text is entered into the website and formatted with the desired font, size, type, color, etc., the user saves the design to a design database as indicated at block 254 in FIG. 3B.

After the customer saves the design to the design database at block 254, the customer is then able to purchase boxes having the design as indicated at block 256 in FIG. 3B. After the customer indicates that the design is to be purchased, the customer proceeds to block 242 to enter the quantity of boxes to be purchased and to add the order to the customer's cart. If the customer decides at block 250 to create a custom design having a graphic, then the customer decides at block 258 whether the customer will use an existing graphic (i.e. a graphic already stored in the design database of system 100) or whether the customer will use a custom graphic to be uploaded to system 100 from the customer computer 128.

If the customer decides at block 258 to use an existing graphic, the customer selects the graphic from the database of existing images as indicated at block 260 in FIG. 3B. After the customer selects an existing graphic at block 260, the customer proceeds through the steps at blocks 254, 256 and then proceeds through the steps of blocks 242, 244 in a manner similar to the manner described above. If the customer decides at block 258 to use a custom graphic, then the customer uploads the custom graphic from customer computer 128 to system 100 as indicated at block 262 in FIG. 3A. After the custom graphic is uploaded to system 100, the custom graphic is modified, if necessary, by a systems administrator of system 100 to place the custom graphic in an appropriate format to be handled by system 100 as indicated at block 264 of FIG. 3B.

After the system administrator makes any modifications to the custom graphic, metadata (e.g. a file name) is assigned to the custom graphic as indicated at block 266 of FIG. 3B. After the metadata is assigned to the custom graphic, the custom graphic is added to the customer's web library of graphical images as indicated at block 268 and then the customer is returned to block 258. After the custom graphic is uploaded by the customer, modified by the system administrator, and stored in the appropriate library of system 100, the customer is then able to access the custom graphic as one of the customer's existing designs as indicated by block 260. Thus, from block 258, the customer is able to access any custom graphic that the customer uploaded in the past and then the customer is able to proceed through the steps associated with blocks 254, 256 and through the steps associated with blocks 242, 244 as described above.

If at block 244 the customer does not wish to add any more items to the customer's cart, then the customer reviews the cart (i.e. the customer's order) as indicated at block 270. After reviewing the cart at block 270, the customer decides at block 272 whether to modify the order or whether to checkout. If the customer decides at block 272 to modify the order, then at block 274 the customer modifies those portions of the order, such as the quantity, that do not involve changes to the custom design to be printed on the boxes. After making the modifications to the order at block 274, if the customer does not want to change any of the custom designs to be printed on the boxes, then the customer returns to block 270. On the other hand, if the customer does want to change any of the custom designs, then the customer modifies the design as indicated at block 276 of FIG. 3B. After modifying the design at block 276, the customer proceeds to block 254 and continues from block 254 in the manner described above.

If at block 272 the customer decides not to make any changes to the order, then the customer is linked to those portions of the website that permit the customer to checkout as indicated at block 278 of FIG. 3B. During the checkout process, the customer is able to create or edit the customer's profile, which includes information about the customer such as the customer's job title, home phone number, work phone number, etc., as indicated at block 280. Also during the checkout process, the customer decides at block 282 whether to set up or edit the shipping and/or billing addresses associated with the order. If the customer decides to set up or edit the shipping and/or billing addresses at block 282, then the customer uses the website to enter the address information as indicated at block 284.

After the customer decides at block 282 not to set up or edit the billing and/or shipping addresses or, alternatively, after the customer enters the desired address information at block 284, the customer then selects the shipping address to which the order is to be shipped as indicated at block 286 of FIG. 3C. It is contemplated by this disclosure that a customer may have more than one shipping address and more than one billing address stored in system 100. After the customer selects the desired shipping address at block 286, the customer uses the website to indicate whether the billing address is the same as the shipping address as indicated at block 288. In the illustrative embodiment, system 100 automatically sets up the billing address to be the same as the shipping address unless the customer indicates otherwise. If the billing address is not the same as the shipping address, then the customer deselects the “billing same as shipping address” default of system 100 and also chooses the desired billing address as indicated at block 290.

After the customer selects the desired shipping and billing addresses, the customer reviews an order summary as indicated at block 292 of FIG. 3C. The page of the website on which the order summary appears also queries the customer to indicate whether the customer has read and agreed with the user agreement as indicated at block 294. If the customer indicates at block 294 that the customer has not read the user agreement, then system 100 responds by presenting on customer computer 128 the user agreement for review by the customer as indicated at block 296. After the customer has reviewed the user agreement at block 296, the customer decides at block 298 whether or not the customer agrees with the terms of the user agreement. If the customer indicates at block 298 that the customer does not agree with the user agreement, then the customer is logged out of system 100 as indicated at block 300.

If the customer indicates at block 298 that the customer agrees with the user agreement or, if at block 294 the customer indicates that the customer has already read and agreed with the terms of the user agreement, then the customer proceeds with the checkout process as indicated at block 310 of FIG. 3C. During the checkout process, the customer enters credit card information into system 100 to pay for the order as indicated at block 312. After the customers enters the credit card information, system 100 operates to validate the credit card information, such as by linking to a third party credit card validation website, as indicated at block 314 of FIG. 3D. During the credit card validation process, a determination as to whether or not the credit card information is valid as indicated at block 316. If the credit card information is not valid, then the customer reenters credit card information as indicated at block 318 and then system 100 proceeds to block 314 in order to validate the reentered credit card information.

If the credit card information or the reentered credit card information, as the case may be, is determined to be valid at block 316, then system 100 is notified of the credit card validation and is provided with a validation number as indicated at block 320 of FIG. 3D. System 100 then returns confirmation to the customer that the credit card has been validated as indicated at block 322. After the customer's credit card information is validated, the order process is essentially complete and system 100 enters into a job preparation phase. Assuming that the order is successfully sent to web server 102, as indicated at block 324, system activates utility software to create a number of files based on the order data provided to system 100 by the customer as indicated at block 326. The file creation process is discussed in further detail below with reference to FIG. 32. In the illustrative embodiment, the file creation process is accomplished, in part, by web server 102 and, in part, by printque server 104.

After the files associated with the customer's order are created, the files are stored electronically in a press ready folder as indicated at block 328 of FIG. 3D. In the illustrative embodiment, the press ready folder that contains the files created at block 326 is resident in memory of server 104. After the created files are stored in the press ready folder, the press operator (or other user of system 100) retrieves the order folder and copies the order folder to the hard drive of print staging computer 105 as indicated at block 330 of FIG. 3E. After the files are copied to the hard drive of computer 105, press software is launched on computer 105 as indicated at block 332 which results in order files (i.e. orders from all customers placing orders) being loaded onto controller 108 as indicated at block 334 and which results in graphics files being loaded onto press computer 106 as indicated at block 348.

After all of the order files are loaded onto controller 108, the operator sequences the orders for printing as indicated at block 336 of FIG. 3E. After the orders are sequenced at block 336, the operator receives hard copies (e.g. paper copies) of the orders in the sequence that the orders are to be run on press 110 as indicated at block 338. The operator then pulls stock sizes of boxes in the appropriate quantities for each of the orders as indicated at block 340. Next, the operator stages the boxes behind printer 110 as indicated at block 342 and places the hard copy of the order with the staged boxes as indicated at block 344. Blocks 340, 342, 344 are associated with the material handling portion of the order fulfillment process.

After boxes are staged behind printer 110 for one or more of the orders to be run, the operator matches the order appearing on the display screen of controller 108 with the hard copy of the order placed with the staged boxes as indicated at block 346 of FIG. 3E. After the operator matches the staged boxes with the order appearing on the screen of controller 108 at block 346, the operator launches an .ijp file (i.e. a graphics file) associated with the order on computer 106 as indicated at block 348. Based on information contained in an .xml file, controller 108 configures press 110, such as by moving print heads 112 to the appropriate locations, for the order to be run and based on information contained in the .ijp file, computer 106 communicates pixel dot information to print heads 112. The .ijp file and the .xml file are discussed below in more detail with reference to FIG. 32.

After controller 108 configures press 110 for the order to be run, machine set up data appears on the display screen of controller 108 and the operator reviews the machine set up data to validate that the machine is set up properly for the order as indicated at block 350 of FIG. 3E. After the machine sets are validated at block 350, the operator initiates the printing process, such as by touching appropriate areas on the display screen of controller 108, which in one embodiment is a touch screen display. During the printing process, the operator runs one box through press 110, as indicated at block 352, and then reviews the box to make sure that print and alignment quality are acceptable, as indicated at block 354. If the quality of the printing is acceptable, then the operator runs the order on press 110 as indicated at block 356.

After the order is run, the operator notes the run quantity on the order paperwork as indicated at block 358 of FIG. 3F and sends a copy of the order paperwork to the billing department as indicated at block 360 of FIG. 3F. The operator also places a copy of the order paperwork with the boxes to be shipped as indicated at block 362. After the boxes are run through press 110 to have the custom designs printed thereon, the boxes associated with each of the orders are staged prior to being shipped to the customer as indicated at block 364. Before the completed order is shipped to the customer, shipping documents, such as bill of lading, are created as indicated at block 366. After the appropriate shipping documents are created at block 366, the completed order is loaded onto a shipping carrier (e.g. truck, van, airplane) and is shipped to the customer as indicated at block 368.

After the completed order is shipped to the customer at block 368, the bill of lading is sent to the billing department as indicated at block 370 of FIG. 3F. After receiving the bill of lading, the billing department matches the bill of lading with the order paperwork as indicated at block 372. The matched paperwork is then filed into a credit card billing file associated with the customer that placed the order as indicated at block 374. Also during the billing process, the billing department matches an invoice to the associated order as indicated at block 376. Next, the billing department enters the credit card charge (i.e. the amount the customer owes for the order) and the invoice number into the payment processor system 130 to receive payment for the order as indicated at block 378.

After the payment processor authorizes payment, a credit card transaction number is received from the payment processor and this credit card transaction number is noted on the invoice as indicated at block 380 of FIG. 3F. The invoices are checked to make sure that all pertinent data is shown on the invoices and then the invoices are filed as indicated at block 382. In the illustrative embodiment, the billing department performs a weekly reconciliation of credit card charges as indicated at block 384.

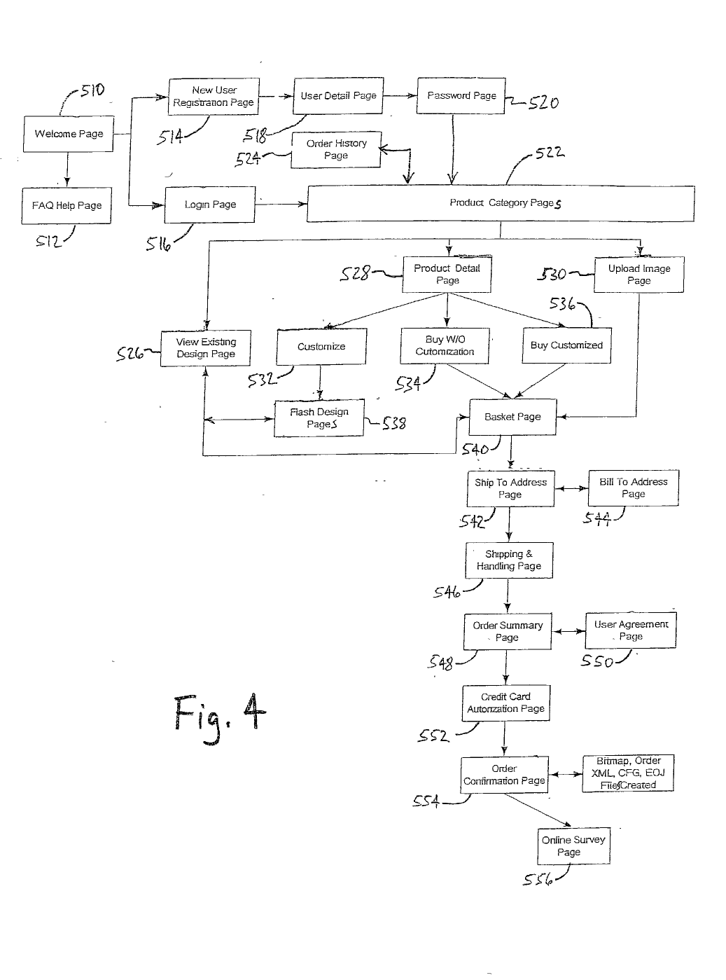

An overview of one embodiment of a website hosted by server 102 is shown diagrammatically in FIG. 4. The website shown in FIG. 4 includes a number of web pages that are linked together. In such an embodiment of the website, when a customer types in the appropriate web address in the address bar appearing on the customer's computer screen, server 102 responds with a Welcome Page 510. Welcome page 510 is referred to elsewhere in this disclosure as a Home page. Welcome page includes information of a general nature explaining to the customer that the customer has navigated to a website that permits packages with custom printed graphics to be ordered. From page 510, the customer is able to access a FAQ Help page 512, a New User Registration page 514, or a Login page 516.

If the customer navigates to page 512, the customer is presented with various answers to frequently asked questions in order to explain, in further detail, the custom package-printing process. If the customer is a new customer, the customer is able to begin the registration process on page 514 and then complete the registration process by entering appropriate information on a User Detail page 518 and a Password page 520. If the customer is already a registered user of the website, the customer enters the customer's user ID and password on Login page 516. After the customer either registers as a new user on pages 514, 518, 520 or logs in on page 516, the customer is presented with series of Product Category pages 522. Using pages 522, the customer makes various design selections, such as the size and type of boxes desired by the customer, the area on each of the boxes to have graphics printed thereon, and the particular images and text to be printed on the boxes.

From certain of the pages 522, the customer is able to navigate to an Order History page 524, a View Existing Design page 526, a Product Detail page 528, or an Upload Image page 530. If the customer navigates to page 524, server 102 responds with a list on page 524 showing various details of past orders placed by the customer. If the customer navigates to page 526, server 102 responds with a table on page 526 showing all of the sizes and types of boxes that the customer has ordered in the past along with the customer-assigned names of the graphic designs that were printed on the boxes in the past. If the customer navigates to page 528, the details of the product category, such as box size, box type, substrate type, and the like, selected by the customer on pages 522 are summarized on page 528 and the customer is given the option of navigating to either a Customize page 532, a Buy Without Customization page 534, or a Buy Customized page 536.

If the customer navigates to page 532, the customer is able to create custom designs for the graphics (i.e. images and text) to be printed on the package materials selected by the customer on pages 522. During the customization process, several Flash Design pages 538 are presented to the customer and the customer enters graphics data on pages 538. For example, using pages 538, the customer is able to enter data pertaining to the following: a field on the package materials where the graphics are to be printed, the image or images from an art library to be printed, the size of the image(s), the color of the image(s), the position within the selected field where each of the images is to be printed, the text to be printed on the package materials, the size of the text, the font in which the text is to be printed, the color of the text, and the position within the selected field where the text is to be printed. The customer may also navigate to pages 538 from View Existing Design page 526 so that the customer can use pages 538 to edit or modify an existing design.

If the customer wants to purchase plain boxes without any customized graphics, the customer will navigate to page 534 as shown in FIG. 4. If the customer has selected a box size on pages 522 that the customer has ordered in the past with one or more custom graphics designs, then on page 528 the customer will be presented with the option of selecting from a drop-down list one of the past custom graphics designs so that the customer does not need to create the same custom graphics design again for the selected size of box. If the customer selects one of the past graphics designs for the particular size of box desired by the customer, then server 102 responds with page 536. Thus, unlike page 526 which shows the customer all of the customers existing designs for all of the sizes of boxes ordered by the customer in the past, the drop down list appearing on page 528 shows only the past graphics design(s) associated with the particular size of box chosen by the customer on pages 522.

Once the customer has either chosen to buy plain boxes at page 534, created a customized graphics design using pages 538, or selected an existing design at page 526 or page 536, server 102 responds with a Basket page 540. Basket page 540 is referred to elsewhere herein as a “Cart page.” Basket page has a table showing the box size and type selected, the name of the customized graphics (if any) to be printed on the boxes, and the unit price of each box. In addition, the customer is able to enter the quantity of boxes the customer desires. Once the customer enters a quantity, the total price of the order is presented to the customer on page 540. From page 540, the customer can either cancel the order or complete the purchase.

If the customer chooses to complete the purchase on page 540, then the customer will enter a ship-to address on a Ship To Address page 542 and will enter a bill-to address on a Bill To Address page 544. If the customer has ordered boxes in the past, then the customer will either confirm or change the customer's ship-to and bill-to addresses on pages 542, 544. After the customer enters, confirms, or changes the ship-to and bill-to addresses on pages 542, 544, server 102 responds with a Shipping & Handling page 546. On page 546 the user selects the type of carrier (e.g. U.S. Postal Service, UPS, Federal Express, and the like) and provides any other pertinent shipping and handling instructions, such as to ship for overnight delivery or to ship by regular mail, for example.

After the shipping and handling data is entered by the customer on page 546, server 102 responds with an Order Summary page 548 on which is shown all of the pertinent order data. The order data shown on page 548 includes shipping method data, address data, box size and type, graphics design name (if any), quantity data, unit price data, and total price data. If the customer has not read and agreed to the terms of a User Agreement, then the customer will navigate to a User Agreement page 550 so that the customer can read and agree to the terms of the user agreement. After the customer indicates on page 548 that the customer is ready to complete the order, such as by clicking on an appropriate icon appearing on page 548, server 102 responds with a Credit Card Authorization page 552. The customer enters appropriate information on page 552 to pay for the customer's order with a credit card.

After the customer enters the credit card payment data on page 552, server 102 responds with an Order Confirmation page 554. The order confirmation page notifies the customer that the order was completed successfully and shows the order number assigned to the customer's order. From page 554, the customer has the option of navigating to an Online Survey page 556 to complete a survey to provide feedback about website. After the customer submits an order, server 102 creates automatically .bmp (bitmap), .xml (extensible markup language), .cfg (configuration), and .eoj (end of job) files as indicated at block 560. These files are created based on the order data provided by the customer and are discussed below in more detail in connection with FIG. 32.

Those skilled in the art will appreciate that the illustrative links between web pages 510-556, which are indicated by arrows in FIG. 4, are just one possible way of linking pages 510-556 together and that other linking arrangements are within the scope of this disclosure. In addition, it is within the scope of this disclosure for some or all of pages 510-556 to have a master menu for linking directly to certain other pages. For example, an order history icon may be provided on every page of the website so that the customer can navigate to Order History page 524 from each page on the website. It is also within the scope of this disclosure for other types of pages to be included in a website for ordering customized packages. Such other types of pages may include, for example, demonstration pages that a user views to learn how to create custom graphics on the website.

FIGS. 5-31 show screen printouts of an exemplary implementation of a website for placing custom package-printing orders according to this disclosure. Some of the pages shown in FIGS. 5-31 correspond to particular pages that are shown diagrammatically in FIG. 4. In such instances, common reference numerals used.

The description below refers to various graphical or textual images, such as icons, buttons, or dialog boxes that appear on various web pages, as being “selected.” This disclosure is intended to cover all methods for selecting graphical or textual images appearing on a computer screen. Selection of such graphical or textual images may be accomplished, for example, by moving a computer mouse to cause a cursor to overlap a portion of the image to be selected and then clicking (or double clicking) a button on the computer mouse; by using left, right, up, and down arrow keys on a computer keyboard to highlight various images and then pressing an “Enter” key of the keyboard when the desired image is highlighted; by using a “Tab” key on a computer keyboard to highlight various images and then pressing an “Enter” key of the keyboard when the desired image is highlighted; by touching a computer screen with a light pen on the portion of the screen having the desired image; using voice control software to select the desired image verbally; and, if the computer screen is a touch screen, touching the portion of the touch screen having the desired image. In the description below, when it is stated that a particular web page or window “appears” on the customer's computer screen or that “server 102 responds with” a particular page or window on the customer's computer screen, or a similar such phrase, such statements mean that server 102 is transmitting data to the customer's computer to cause the web page or window to cause the web page or window to appear on the customer's computer screen.

Referring now to FIG. 5, when the customer enters a world wide web address 570, such as, for example, www.packagegenie.com (which, in one embodiment, is the web address associated with system 100), into an address bar 572 of the customer's computer screen, server 102 responds with Home page 510. Page 510 has a You've Got Questions icon 574, a Simply Wish icon 576, a Check It Out icon 578, a News icon 580, a Sign In icon 582, and About Us icon 584, a Privacy Policy icon 586, and a User Agreement icon 588. If the customer selects icon 574, FAQ Help page 512 appears on the customer's computer screen with a list of questions and answers that the customer may read to learn more about the website. If the customer selects icon 576, additional information is provided to the customer about the website.

If the customer selects icon 578 on page 510, a demonstration of the website appears on the customer's computer screen. An exemplary demonstration of the website is shown in the priority provisional application, U.S. Provisional Patent Application Serial No. 60/313,073 which was filed Aug. 17, 2001 and which is incorporated by reference herein. The demonstration teaches the customer how to select packaging materials and how to create custom graphics to be printed on the selected packaging materials. If the customer selects icon 580, then a list of hypertext links to various magazine articles, journal articles, informational bulletins, and the like appear on the customer's computer screen. If the customer selects one of the hypertext links, then the associated article or bulletin appears on the customer's computer screen. If the customer selects icon 584, then contact and/or background information about the organization hosting the website appears on the customer's computer screen. If the customer selects icon 586, a privacy policy appears on the customer's computer screen. If the customer selects icon 588, then a user agreement appears on the customer's computer screen.

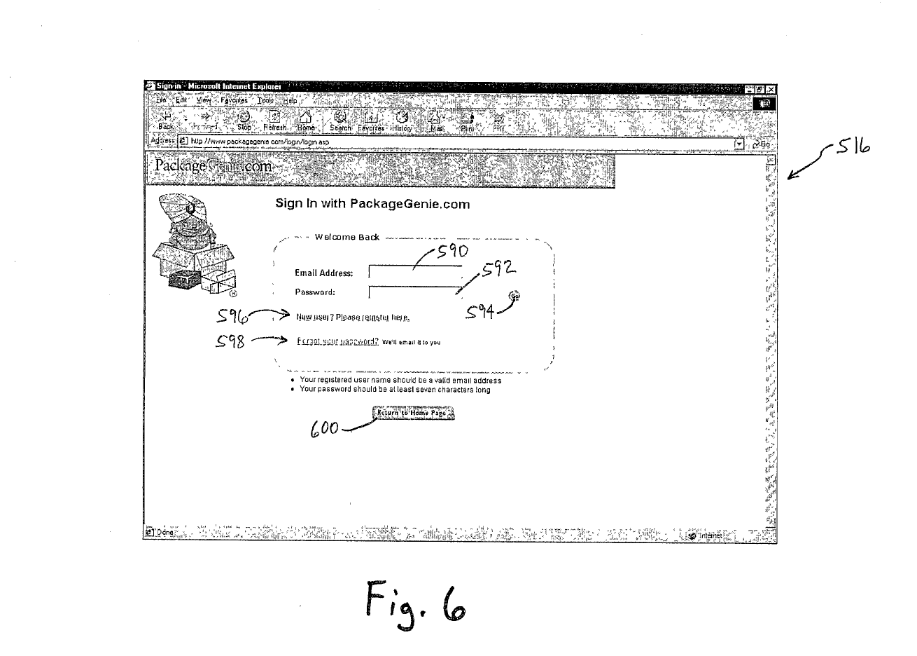

If the customer selects icon 582 on page 510, then server 102 responds with Sign In page 516 as shown in FIG. 6. Page 516 includes an E-mail Address entry box 590, a Password entry box 592, a Go icon 594, a “New User? Please Register Here” icon 596, a “Forgot Your Password?” icon 598, and a “Return to Home Page” icon 600. If the customer is a registered user of the website, the customer types the customer's e-mail address and password into boxes 590, 592, respectively, and selects icon 594 to gain access to the portion of the website that permits the customer to place custom package-printing orders. If the customer is a new user, the customer selects icon 596 and server 102 responds with one or more web pages (not shown) on which the customer provides contact information, including the customer's e-mail address, and enters the password to be assigned to the customer.

After the customer registers as a new user, server 102 automatically sends an e-mail to the customer's e-mail address advising the customer that the customer has successfully registered as a user of the website and listing the customer's “log in” information, namely, the customer's password and the customer's user name, which in the illustrative embodiment is the customer's e-mail address. The e-mail that is sent to the customer after the customer registers as a new user also provides an e-mail address that can be used by the customer to contact the entity hosting the website if the customer has any questions or concerns. If the customer is a registered user but has forgotten his or her password, then the customer selects icon 598 which prompts server 102 to send an e-mail to the customer's e-mail address with the customer's password. If the customer selects icon 600 on page 516, then the customer is returned to page 510.

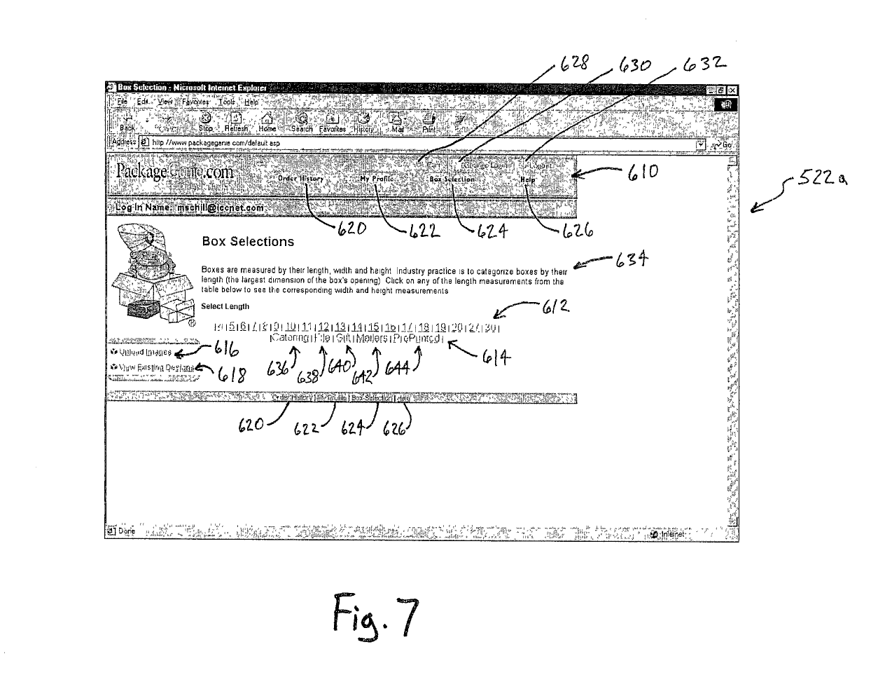

After the customer has signed in by entering the appropriate information in boxes 590, 592, or alternatively, after the customer has registered as a new user, server 102 responds with a first Box Selections page 522a as shown in FIG. 7. Box Selections page 522a comprises a menu bar 610, a set of box length icons 612 (numbered 4-20, 27 and 30 in the illustrative example), a set of specialized package icons 614, an Upload Images icon 616, and a View Existing Designs icon 618. Menu bar 610 includes: an Order History icon 620, a My Profile icon 622, a Box Selection icon 624, a Help icon 626, a Cart icon 628, a Change Login icon 630, and a Logout icon 632. Icons 620, 622, 624, 626 are duplicated on the bottom region of page 522a. Page 522a also has an explanatory paragraph 634 which explains to the customer that boxes are measured by their length, width, and height; that industry practice is to categorize boxes by their length, which is the largest dimension of the opening of the box; and that the customer should select any of the length measurements (i.e. icons 612) listed in the table below the paragraph to see the corresponding width and height measurements.

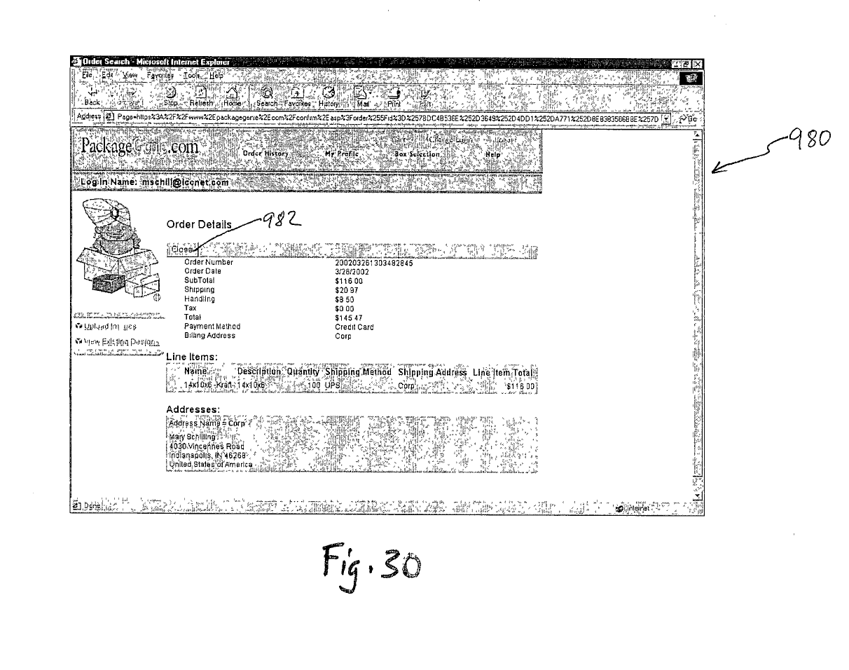

If the customer selects Order History icon 620, an Order History page 524 providing certain information of past orders by the customer is displayed on the customer's computer screen as shown, for example, in FIG. 30 and as described in further detail below. If the customer selects My Profile icon 622, server 102 responds with a web page (not shown) allowing the customer to change the information contained in the customer's profile, such as the customer's name, company name, job title, and the like. If the customer selects Box Selection icon 624, server 102 responds with page 522a. If the customer selects Help icon 626, server 102 responds with a help window or a help page (not shown) which explains the features of the system in more detail to the customer.

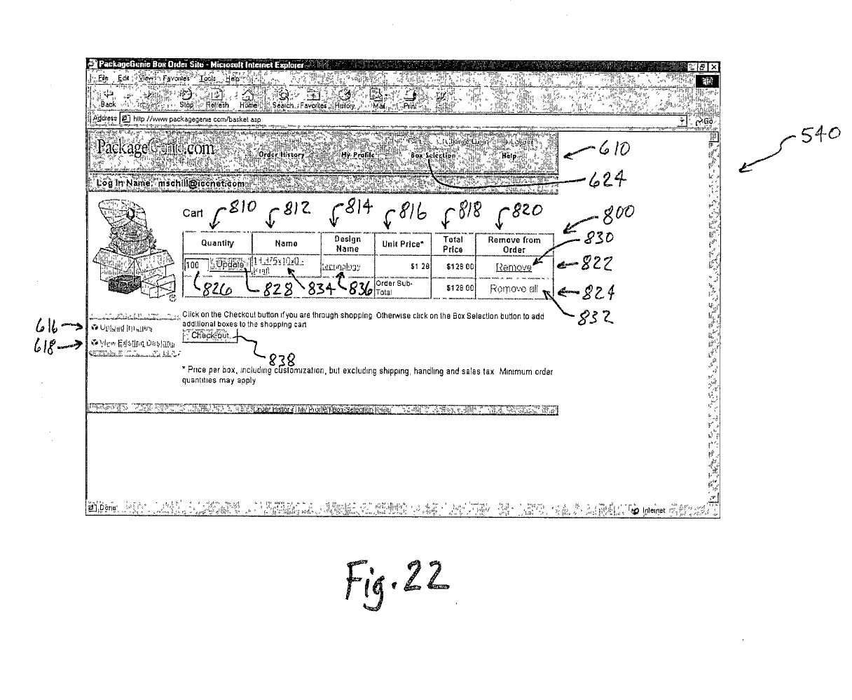

If the customer selects Cart icon 628, server 102 responds with a Cart page 540 as shown, for example, in FIG. 22 and as described in further detail below. If the customer selects Change Login icon 630, server 102 responds with a web page (not shown) allowing the customer to change the customer's e-mail address and/or password. If the customer selects Logout icon 634, the customer's active session on the website ends, and server 102 responds with a web page (not shown) thanking the customer for visiting the website and having an icon that the customer can select to return to Home page 510. Menu bar 610 is present on every html (hypertext markup language) based page of the website except for pages 510, 516 and any of the pages associated with icons 574, 576, 578, 580, 584, 586, 588 of page 510 and associated with icons 596, 598, 600 of page 516. Menu bar 610 is also present in the background when the customer is entering information in a flash mode, which is described in detail below.

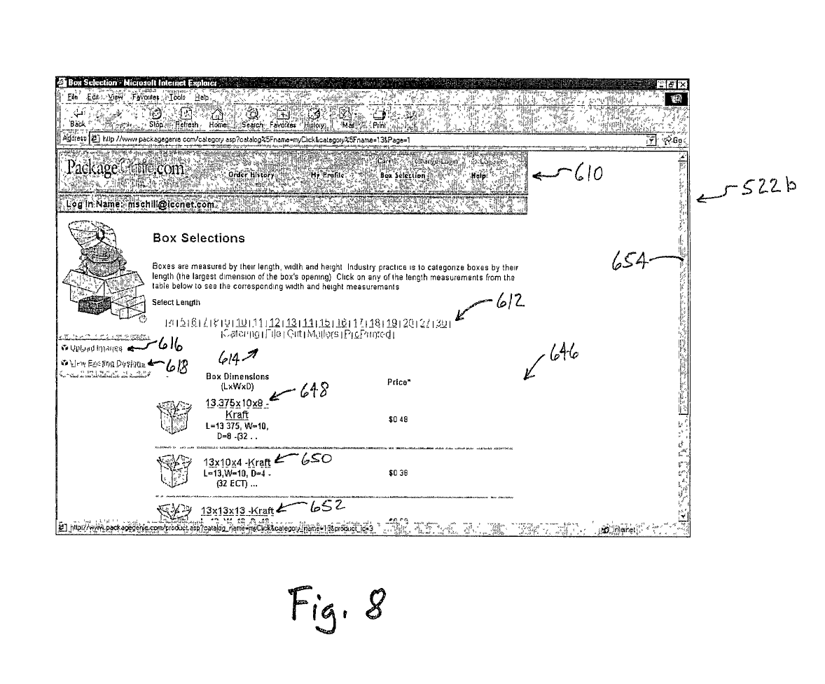

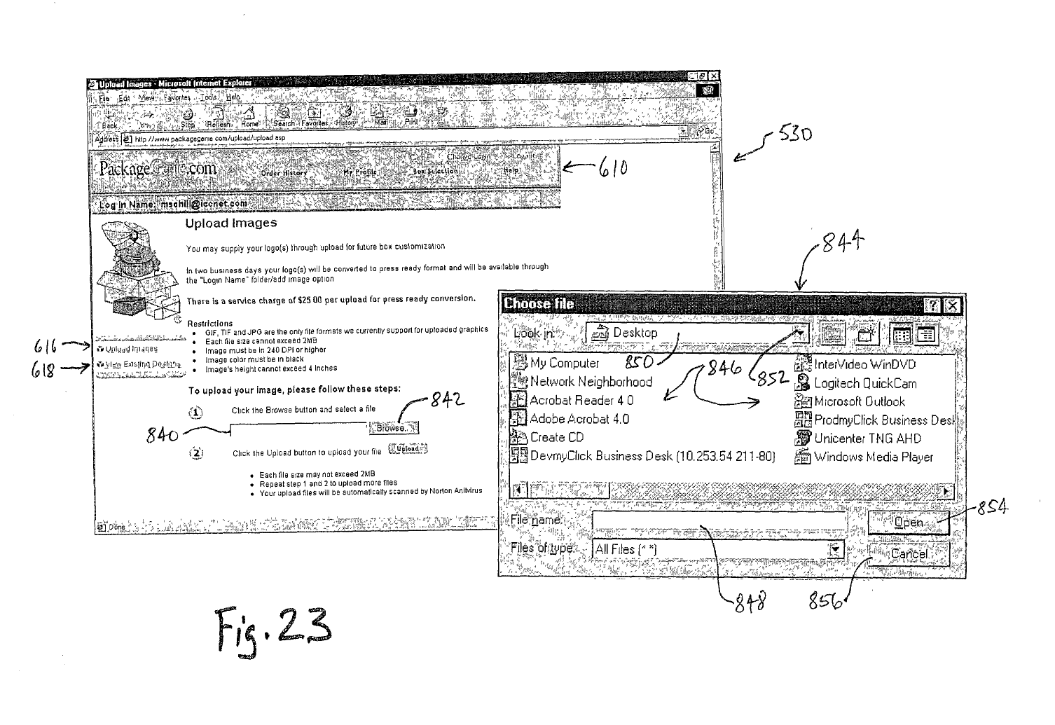

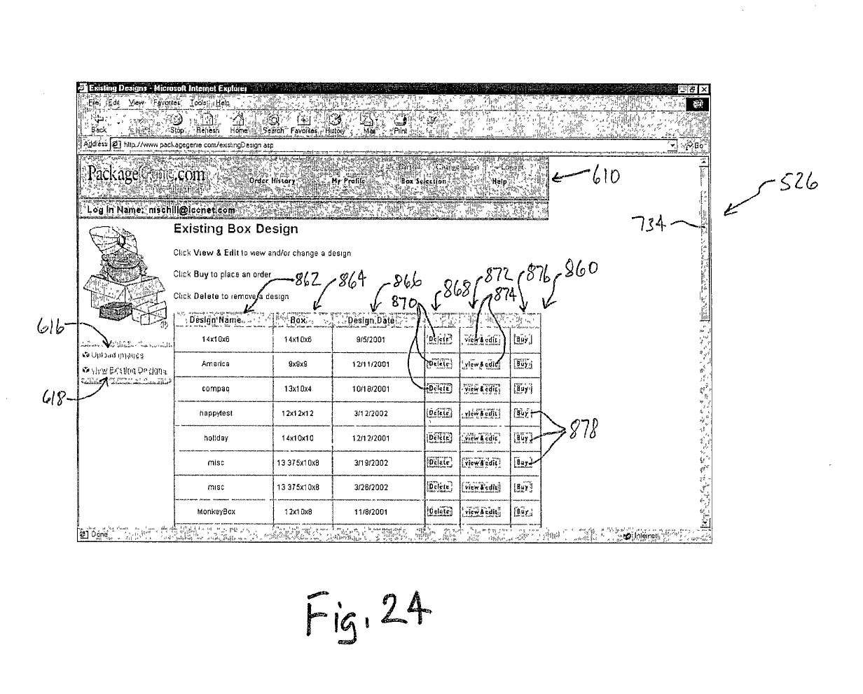

If the customer selects Upload Images icon 616, server 102 responds with an Upload Images page 530, shown in FIG. 23. If the customer selects View Existing Designs icon 618, server 102 responds with an Existing Box Design page 526, shown in FIG. 24. If the customer selects one of box length icons 612 from the set of select length icons 612, server responds with a second Box Selections page 522b as shown, for example, in FIG. 8. Each of the box length icons 612 represents the approximate length, in inches, of one or more box sizes that are available for purchase. After a particular box length icon 612 has been selected on page 522a by the customer, server 102 is programmed so that only the boxes having an approximate length that matches the selected box length icon 612 are presented for possible selection to the customer on page 522b.

Set of icons 614 that are selectable by the customer on page 522a in the illustrative example include a Catering icon 636, a File icon 638, a Gift icon 640, a Mailers icon 642, and a Preprinted icon 644. If the customer selects icon 636, server 102 responds with a web page having a list of available boxes that are typically used for catering. Such catering boxes may include, for example, boxes in which meals are delivered and may have built-in drink holders or openable and closeable top flaps. If the customer selects icon 638, then server 102 responds with a web page having a list of available boxes, such as banker's boxes, that are used for the storage of file folders, binders, documents, and the like. If the customer selects icon 640, then server responds with a web page having a list of available gift boxes that include, for example, small boxes in which jewelry may be packaged or boxes having a substrate of highly decorative material. If the customer selects icon 642, then server 102 responds with a web page having a list of available boxes that are sized and configured for mailing various items such as books, letters, videotapes, digital video disks (DVD's), audio disks, audio tapes, and the like. Each of the boxes associated with icons 636, 638, 640, 642 may have custom graphics added thereto by the customer, if desired, or may be purchased plain.

If the customer selects icon 644, server 102 responds with a web page having a list of available box sizes that already have certain graphics preprinted thereon. For example, boxes preprinted with graphics having a Valentine's day theme (e.g. images of hearts, roses, and/or cupid, along with appropriate text such as “Happy Valentine's Day”), a Mother's day theme (e.g. images of a butterfly and/or a tulip in a garden, along with appropriate text such as “Happy Mother's Day”), a Christmas theme (e.g. images of a snowman, Santa Claus, a Christmas tree, and the like, along with appropriate text such as “Merry Christmas” or “Happy Holidays”), and a birthday theme (e.g. images of balloons, confetti, streamers, and/or a birthday cake, along with appropriate text such as “Happy Birthday”). The preprinted graphics described in the preceding sentence are just a few examples of the types of preprinted graphics that may be offered on the website. In addition, boxes of several different sizes may be offered for each theme and certain areas on the preprinted boxes may be available for customization. Other types of boxes and other types of packaging materials may be offered on the website in accordance with this disclosure. For example, various sizes of pizza boxes may be offered on the website.

Referring now to the second Box Selection page 522b shown in FIG. 8, a table 646 of all boxes that are associated with the box length icon 612 selected on page 522a is presented to the user on page 522b. In the illustrative example, the box length icon 610 numbered “13,” which corresponds to a box length of about 13 inches (33.02 cm), was chosen on page 522a and there are multiple available boxes having a length dimension of about 13 inches as shown in table 646 of page 522b. Table 646 has a “Box Dimensions” column and a “Price” column. A “13.375×10×8-Kraft” icon 648, a “13×10×4-Kraft” icon 650, and a “13×13×13-Kraft” icon 652 can be seen in the Box Dimension column of FIG. 8. Additional “length×width×depth” icons (not shown), if any, in the Box Dimensions column are viewable by moving a scroll bar 654 downwardly on the customer's computer. The unit price for each box associated with icons 648, 650, 652 appears in the Price column of table 646 to right of respective icons 648, 650, 652.

The length, width, and depth dimensions, in inches, of the available boxes are encoded in icons 648, 650, 652. For example, the “13” in icon 650 means that the associated box has an opening with a length of 13 inches (33.02 cm), the “10” in icon 650 means that the associated box has an opening with a width of 10 inches (25.4 cm), and the “4” in icon 650 means that the associated box has an opening with a depth of 4 inches (10.16 cm). Icons 648, 652 and any other icons appearing in the Box Dimensions column of table 646 of page 522b may be decoded in a similar manner to determine the length, width, and depth dimensions of the opening of the associated box. The word “Kraft” appearing in icons 648, 650, 652 indicates that the substrate (i.e. the outside layer) of the box is kraft paper. Kraft paper is a brown substrate well-known in the packaging industry for constructing corrugated boxes. Boxes or packages with other substrates are contemplated by this disclosure. For example, a white substrate or a wave flute substrate are available in one embodiment of system 100.

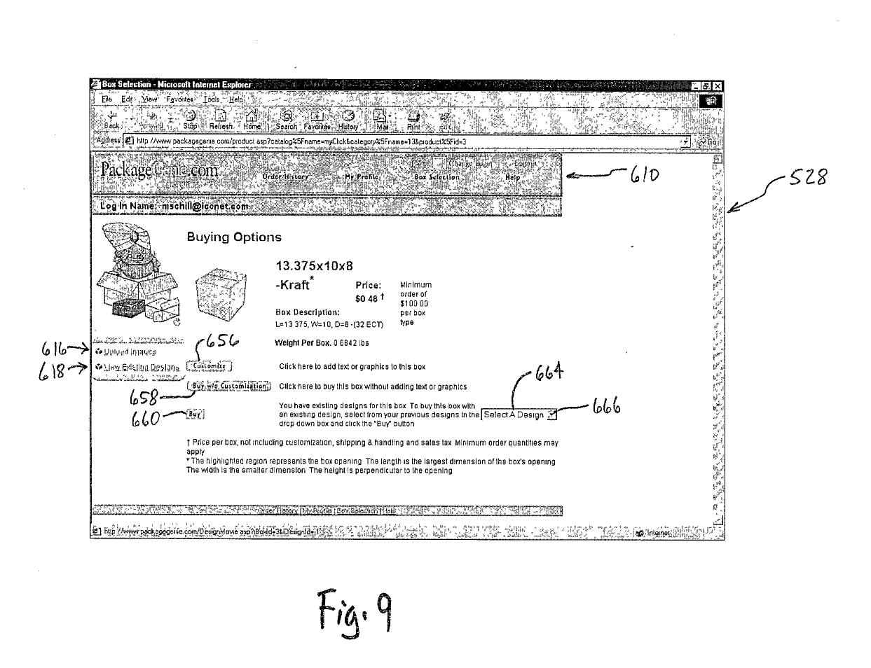

If the customer selects one of icons 648, 650, 652 (or any similar icon associated with boxes of other sizes) on page 522b, server 102 responds with a first buying options page 528, an example of which is shown in FIG. 9. The illustrative example of page 528 is associated with icon 648 of page 522b. Page 528 provides the customer with information regarding the selected box size, the substrate type of the selected box, unit price of the selected box, and the weight per box for the selected box. Page 528 also provides the customer with the options to purchase the selected box with or without customization. Page 528 includes a Customize icon 656, a “Buy w/o Customization” icon 658, and a Buy icon 660.

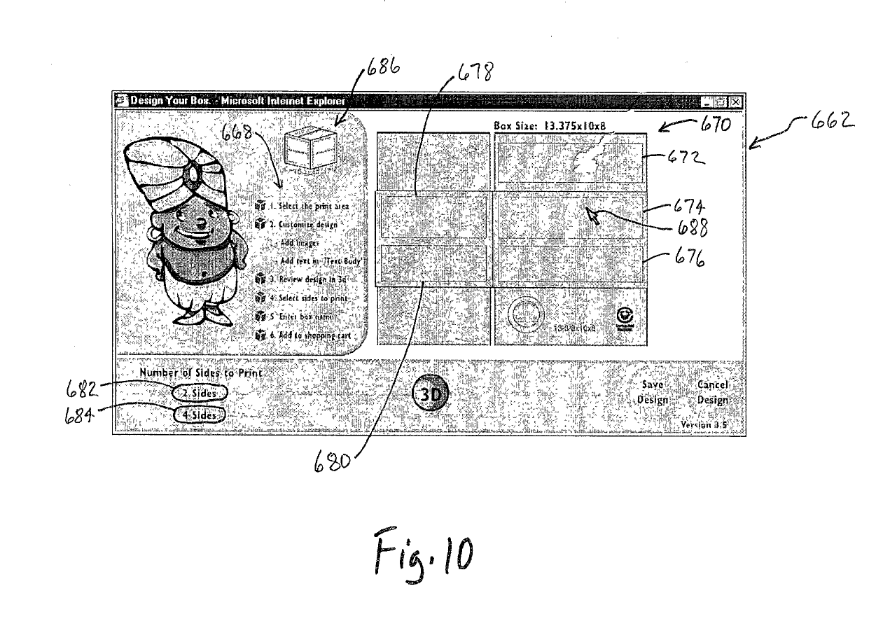

If the customer wants to design custom graphics to be printed on the box, then the customer selects icon 656 and server 102 responds with a Print Area Selection window 662 as shown in FIG. 10. If the customer wants to buy plain boxes without any custom graphics, then the customer selects icon 658 and server 102 responds with a Cart page similar to illustrative Cart page 540, shown in FIG. 22, but with information relating to the plain boxes that the customer plans to order.

Page 528 has a dialog box 664 and an arrow icon 666 that is associated with dialog box 664 as shown in FIG. 9. If the customer has ordered the selected size of box with one or more custom graphics designs in the past, then the customer has the option of selecting icon 666 so that a menu of the names given to the previous custom graphics designs by the customer will appear adjacent to box 664. The customer may then select one of the names appearing in the menu and the name will appear in box 664. Upon selection of one of the names from the menu, the menu disappears from page 528.

After the customer selects one of the past custom graphics designs from the menu so that the name of the selected custom graphics design appears in box 664, the customer then may select icon 660 which results in server 102 responding with a Cart page containing the pertinent information about the boxes and custom graphics that the customer plans to order. The customer may then complete the order as discussed below in more detail with regard to page 540 and subsequent pages in the ordering process. Thus, by selecting on page 528 a custom graphics design that the customer has ordered in the past, the customer does not have to recreate the same design.

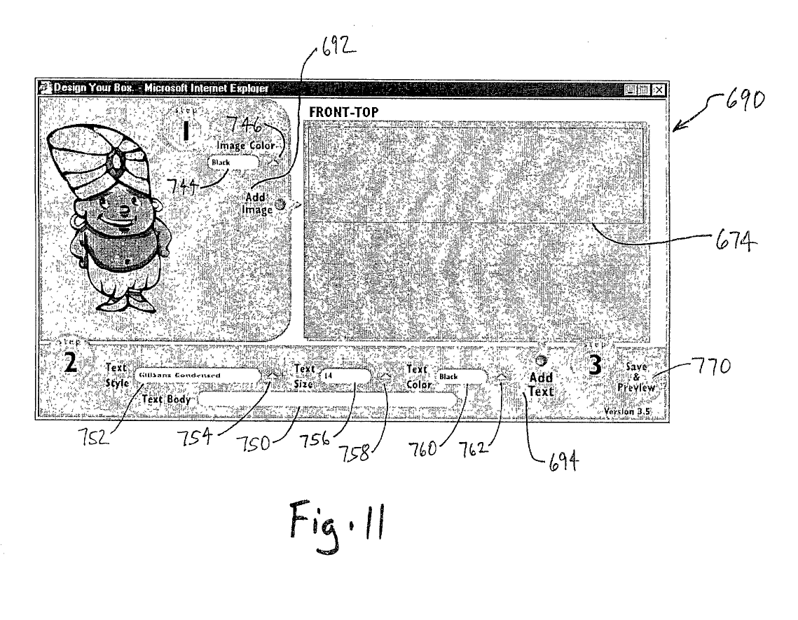

Referring now to FIG. 10, which shows Print Area Selection window 662 that appears on the customer's computer screen after the customer selects icon 656 on page 528, a list of instructions 668 appear on the left portion of window 662 and a layout template 670, which shows half of the selected box as it would appear if it were flat in a knock-down configuration, appears on the right portion of window 662. The illustrative instructions of list 668 are as follows: 1. Select the print area; 2. Customize design -Add images, -Add text in “Text Body”; 3. Review design in 3d; 4. Select sides to print; 5. Enter box name; and 6. Add to shopping cart. Window 662 of FIG. 10 and the windows of FIGS. 11-21, discussed below, correspond to the Flash Design Pages block 538 of FIG. 4.

Template 670 indicates pictorially the regions or fields on the selected box that can have custom graphics printed thereon. In the illustrative example there are five separate fields that can be selected. The customer may design each field with different graphics or with the same graphics, as desired. Thus, in the illustrative example of FIG. 10, up to five separate graphic designs may be printed on the selected box in the associated five fields. These five fields include a top field 672, an upper front field 674, a lower front field 676, an upper side field 678, and a lower side field 680. Field 672 corresponds to a first top flap of the selected box; fields 674, 676 correspond to a major panel of the selected box; and fields 678, 680 correspond to a minor panel of the selected box.

The customer has the option to design the custom graphics for printing on two sides, or on four sides of the selected box by selecting either a “2 Sides” icon 682 or a “4 Sides” icon 684. Icons 682, 684 are mutually exclusive such that selecting one of icons 682, 684 automatically causes the other of icons 682, 684 to be de-selected. With regard to icons 682, 684, a “side” is considered to be either a major panel or a minor panel, along with any associated top and bottom flaps. A box in a knock-down or flat configuration that is run through press 110 will have two sides facing upwardly toward print heads 112 and two side facing downwardly toward table 118. Thus, in FIG. 10, template 670 shows two “sides,” with fields 672, 674, 676 being associated with one of the sides and with fields 678, 680 being associated with the other of the sides.

If icon 682 is selected, then printing is available for the two “sides” of the box that are shown in template 670. If icon 684 is selected, then the graphics designed for printing on the two “sides” of the box shown in template 670 is also printed on the two “sides” of the box not shown in template 670. Thus, in the illustrative embodiment of system 100, in order to print on four sides of the box, the box must be run through press 110 a first time so that printing occurs on two of the four sides, then the box must be flipped over and run through press 110 a second time so that printing occurs on the other two of the four sides. As a result of the extra processing required to print on four sides of the box, server 102 is configured to increase the price per unit of the selected box if the customer chooses icon 684.

A three dimensional box rendering 686 in window 662 of FIG. 10 shows the relative locations of fields 672, 674, 676, 678, 680 on an assembled box. The customer selects one of fields 672, 674, 676, 678, 680 for designing custom graphics by moving a cursor 688 over fields 672, 674, 676, 678, 680 until cursor 688 is situated in the desired field. As the user moves cursor 688 over fields 672, 674, 676, 678, 680, the color of the particular field 672, 674, 676, 678, 680 in which cursor 688 is situated on template 670 changes on template 670 and on rendering 686 to indicate which field is selected.

When the customer actually clicks on a particular one of fields 672, 674, 676, 678, 680 to select it, server 102 responds by displaying on the customer's computer screen a Selected Print Area window 690 as shown, for example, in FIG. 11. Window 690 has an enlarged image of whichever of fields 672, 674, 676, 678, 680 is selected on window 662. In the illustrative example, field 674 has been selected with cursor 688 on window 662 and therefore, window 690 shows an enlarged image of field 674. Window 690 has an Add Image icon 692 that a customer selects if the customer wants to add an image to the selected field appearing on window 690 and an Add Text icon 694 that the customer selects if the customer wants to add text to the selected field appearing in window 690.

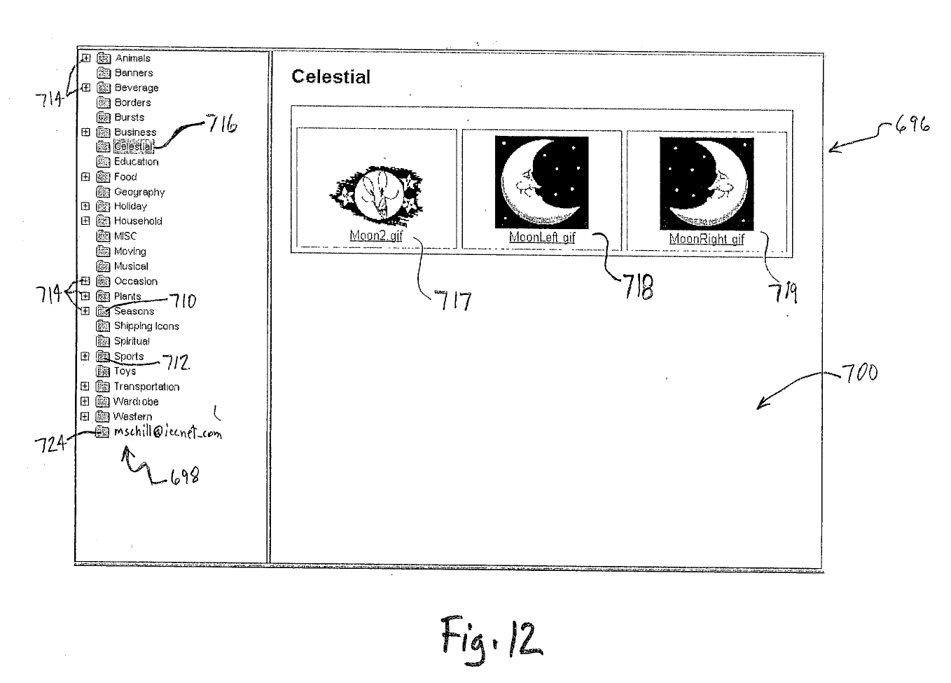

If, on window 690, the user selects icon 692, server 102 responds with an Art Library window 696 as shown, for example, in FIG. 12. Window 696 has a directory listing 698 and a preview window portion 700. When window 696 first appears on the customer's computer screen, window portion 700 is blank. Directory listing 698 has a plurality of folders, each of which contains one or more images related to the subject matter indicated by the title of the folder. Some folders contain sub-folders that further subdivide the subject matter into different categories and that contain various images therein. As one example, a Seasons folder 710 contains sub-folders named Summer, Spring, Fall, and Winter. As another example, a Sports folder 712 contains sub-folders named Baseball, Basketball, Football, etc. A “plus-sign” icon 714 adjacent a folder indicates that the folder contains sub-folders.

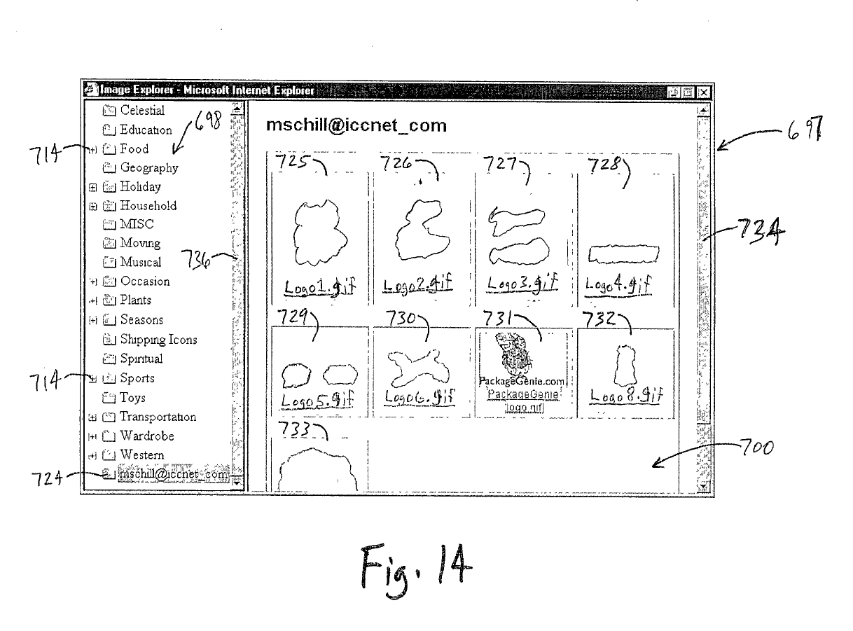

In the illustrative example shown in FIG. 12, a Celestial folder 716 is selected by the customer which results in three images 717, 718, 719 contained in that folder of the art library being shown on preview window portion 700. If the customer selects one of the preview images appearing on window portion 700, server 102 responds by showing a large view of the selected image in preview window portion 700. By way of example, if the customer selects preview image 718 from the three 736 are provided if window 697 is not large enough for all of the images in window portion 700 or for all of the folders in directory listing 698, respectively, to be seen simultaneously on the customer's computer screen as shown in FIG. 14.

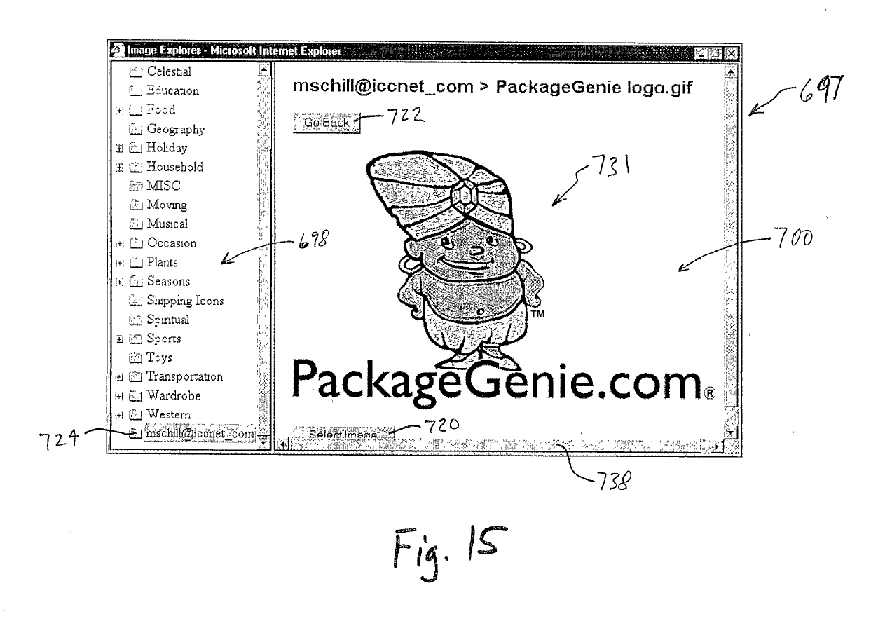

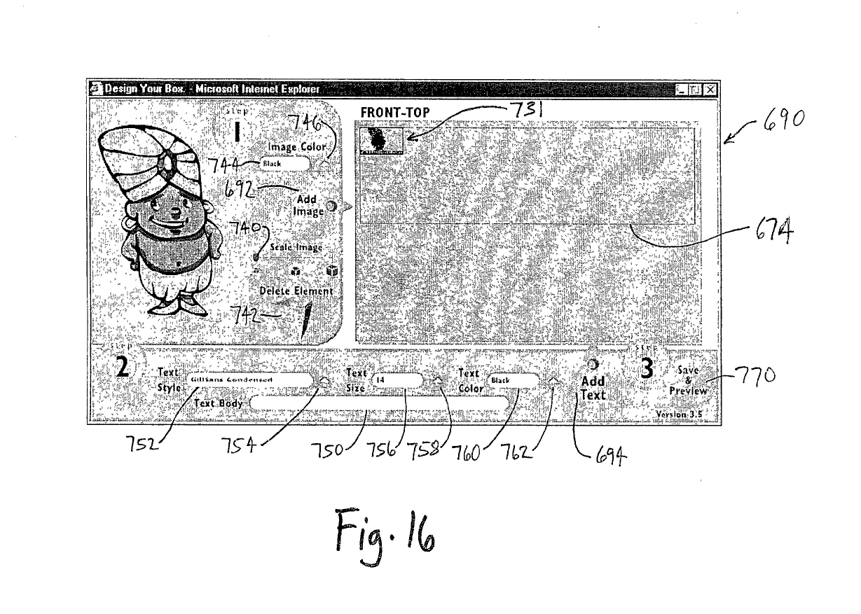

As was the case with the images associated with the folders of the “stock” art library, once the set of images from folder 724 are displayed in window portion 700, the customer simply selects the particular custom graphics design that the customer wants to add to the selected field of the selected box. In the illustrative example, graphics design 731 is selected in FIG. 14 and, as a result, server 102 responds by displaying an enlarged view of design 731 along with icons 720, 722 on window portion 700 as shown in FIG. 15. A horizontal scroll bar 738 is provided if window 697 is not large enough for the enlarged image as shown in FIG. 15. Icons 720, 722 are used in window 697 in the same manner as described above with respect to window 696 to either select the image or to return window portion 700 to its previous state. In the illustrative example, icon 720 is selected on window 697 of FIG. 15 and, as a result, server 102 responds by displaying window 690 on the customer's computer screen with design 731 in an upper left comer of field 674 as shown in FIG. 16.

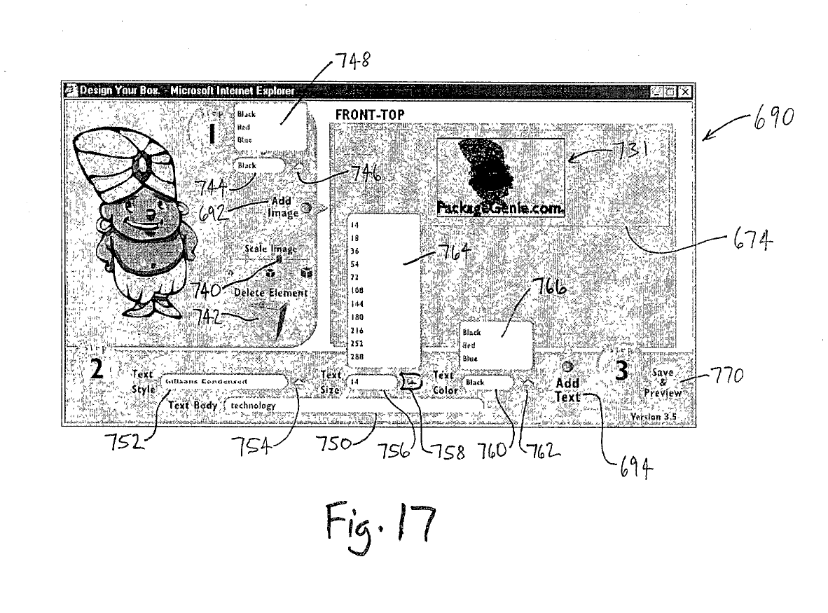

Whenever any image, design, or graphic (these terms are generally used interchangeably herein), such as design 731, is added to the selected field, such as field 674, server 102 adds a Scale Image slider 740 and a Delete Element icon 742 to window 690 as shown, for example, in FIG. 16. Server 102 is configured so that the customer is able to click-and-drag any graphics or text appearing in the selected field on window 690 to reposition the graphics or text within the field. In addition, server 102 is configured so that, after the customer selects an image appearing in the selected field, such as with a single mouse click on the image, the customer is then able to click-and-drag slider 740 to change the size of the selected image. For example, when image 731 is selected in field 674 and the customer moves slider 740 from a first position, shown in FIG. 16, to a second position, shown in FIG. 17, the size of image 731 increases from a small size, shown in FIG. 16, to a larger size, shown in FIG. 17. Slider 740 is movable to any desired position between two extreme positions to adjust the size of a selected image or text block. If the customer selects icon 742 after an image or block of text is selected, the selected image or block of text is deleted from the field appearing on window 690.

Window 690 includes an Image Color dialog box 744 and an arrow icon 746 alongside box 744 as shown in FIGS. 11 and 16-18. If the customer selects icon 746, server 102 responds by displaying a color selection menu 748 in window 690 in the area above box 744 and icon 746 as shown in FIG. 17. Menu 748 has a list of the colors that are available for printing the image, such as image 731, added to the selected field, such as field 674. In the illustrative embodiment, the available colors are black, red, and blue. It is within the scope of this disclosure for more or less colors than those shown in illustrative menu 748 to be available for printing images on packaging materials. It is also within the scope of this disclosure for server 102, to eliminate colors from appearing in menu 748 if such colors are incompatible with the type of substrate of the selected box. For example, if the selected box has kraft paper as its substrate, then the color yellow is eliminated from menu 748, even if one or more of print heads 112 is equipped with yellow ink, because yellow ink does not show up suitably on kraft paper. In some embodiments of system 100, server 102 is configured to determine whether a particular color, which is otherwise not compatible with the substrate type, is outlined or appears on a background of a color that is compatible with the substrate type, in which case, the particular color is not eliminated from menu 748.

After the customer selects the desired color from the list of available colors listed on menu 748, such as with a mouse click, server 102 responds by automatically closing menu 748 and displaying the selected color in box 744. If the customer selects a desired color from menu 748 prior to adding the image to the selected field, then the image will be added to the field in the desired color. If the customer adds an image to the selected field and then wants to change the color of the image, the customer first deletes the image, such by mouse clicking on the image then mouse clicking on the Delete Element icon 742, and then the customer selects the desired color from menu 748, selects Add Image icon 692, and then proceeds as described above to select the desired image.

In addition to adding images from the art library, the customer has the option of adding text to the selected field on window 690 as previously mentioned. Window 690 has a Text Body dialog box 750 in which the customer enters the desired text, a Text Style dialog box 752, an arrow icon 754 associated with box 752, a Text Size dialog box 756, an arrow icon 758 associated with box 756, a Text Color dialog box 760, and an arrow icon 762 associated with box 760 as shown in FIGS. 11 and 16-18. If the customer selects arrow icon 754, server 102 responds by displaying a menu of text styles (not shown) in the area above box 752 and icon 754. The text style menu lists a multitude of text styles or fonts from which the customer can choose. This disclosure contemplates that any known font may be included in the menu associated with icon 754.

If the customer selects arrow icon 758, server 102 responds by displaying a menu 764 of text sizes as shown in FIG. 17. Menu 764 lists a multitude of text sizes, from which the customer can choose. Although illustrative menu 764 lists eleven different text sizes ranging from 14 point to 288 point, this disclosure contemplates that more or less text sizes may be included in menu 764. If the customer selects arrow icon 762, server 102 responds by displaying a menu 766 of colors available for printing the text as also shown in FIG. 17. In the illustrative embodiment, the available text colors are black, red, and blue. As was the case with menu 748, server 102 may be configured to eliminate colors from menu 766 that are incompatible with the substrate type of the selected box.

It is within the scope of this disclosure for hues other than those shown in illustrative menus 748, 766 to be available for printing images on packaging materials. Furthermore, menus 748, 766 may have different colors available for some of fields 672, 674, 676, 678, 680 than for others. Such a situation may occur, for example, if one or more of print heads 112 of press 110 having ink of a particular color are able to be positioned by actuators 136 over some portions of the packaging materials being run through press 110 but not over other portions of the packaging materials. However, this disclosure contemplates that press 110 may be configured with any number of print heads 112, each of which has ink of any known color, and each of which is able to be positioned over every area of the packaging materials, of whatever size or type, being run through press 110.

Although menus 748, 764, 766 are shown in FIG. 17 as appearing on window 690 simultaneously, in particular embodiments of system 100, server 102 is configured such that only one of menus associated with icons 746, 754, 758, 762 appears on window 690 at any instance in time. Thus, if a user selects one of icons 746, 754, 758, 762 when a menu associated with another of icons 746, 754, 758, 762 is “opened,” server 102 will automatically close the “opened” menu and display the newly selected menu. For each of the menus associated with icons 746, 754, 758, 762, after the menu is opened, the customer simply points at and clicks (or otherwise selects) the desired option listed in the opened menu.

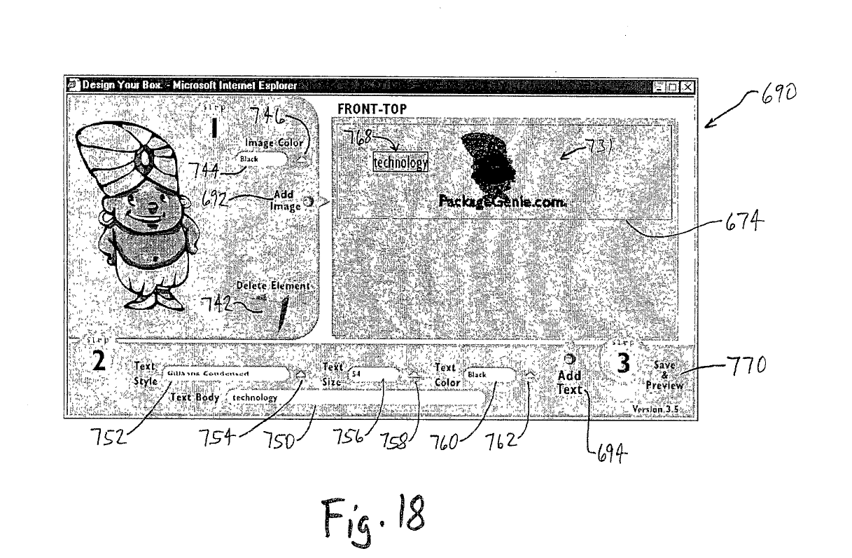

After the customer has entered the desired text in box 750 and formatted the style, size, and color of the text using the menus associated with icons 754, 758, 762, the customer selects Add Text icon 694 and server 102 responds by displaying a text block 768, which contains the text from box 750 with the selected formatting, in the selected field as shown, for example, in FIG. 18 where the word “technology” has been added to field 674. After a text block, such as text block 768, is added to the selected field, the customer can click-and-drag the text block to a desired location within the selected field. If the customer adds text to the selected field and then wants to change the size or color of the text, the customer first deletes the text, such by mouse clicking on the text then mouse clicking on the Delete Element icon 742, and then the customer selects the desired size or color from menus 764, 766, respectively, and selects Add Text icon 694.

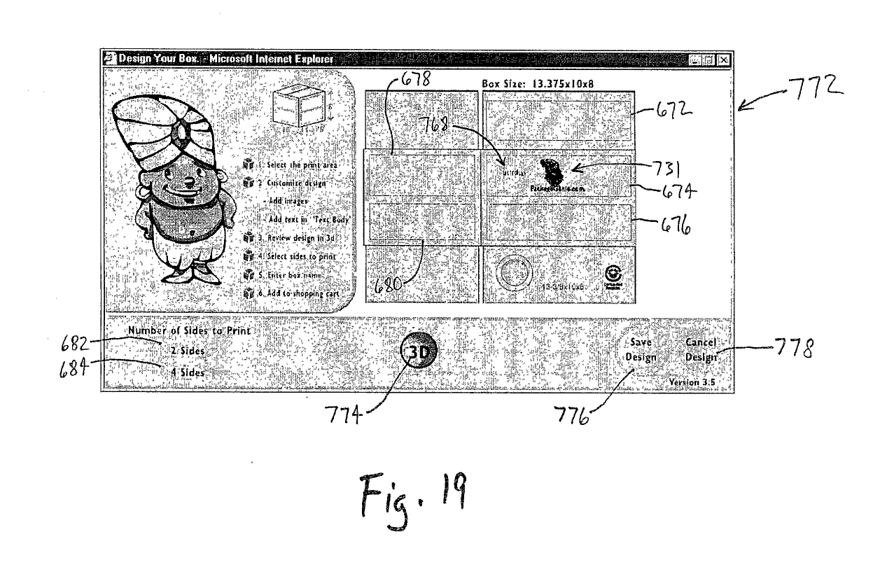

After the customer has added the desired graphics (images and/or text) to the selected area of the selected box, the customer selects a Save & Preview icon 770 and server 102 responds with a Preview window 772 as shown, for example, in FIG. 19. Window 772 shows the selected box in the knock-down configuration with the custom graphics designed by the customer in the associated field(s). In the illustrative example, image 731 and text block 768 are shown in field 674 and the other fields 672, 676, 678, 680 are blank. If the customer wants to add custom graphics to any of fields 672, 676, 678, 680 or if the customer wants to change the custom graphics in field 674, for example, the customer simply selects the desired field 672, 674, 676, 678, 680 with cursor 688 in the manner described above.

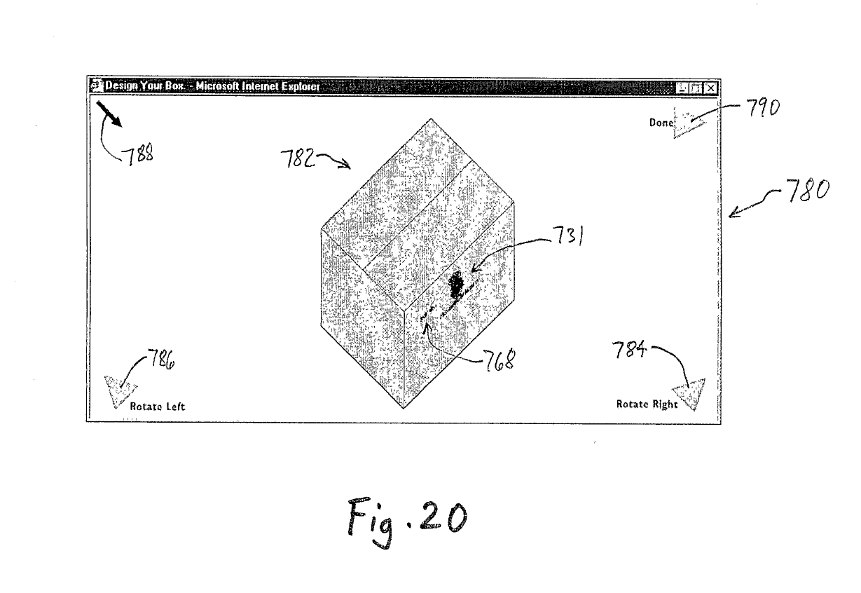

Window 772 has a 3D icon 774, a Save Design icon 776, and a Cancel Design icon 778 as shown in FIG. 19. If the customer decides to cancel the design, the customer selects icon 778, which prompts server 102 to return the customer to Buying Options page 528 and the design is not saved. If the customer decides to view a three dimensional rendering of the box with the custom graphics included in the rendering, the customer selects icon 774, which prompts server 102 to display a 3D window 780 on the customer's computer screen as shown, for example, in FIG. 20. Window 780 includes a three dimensional rendering or representation 782, such as an isometric or perspective view, of the selected box with the custom graphics applied in accordance with the customer's design.

The customer has the option of viewing the box at various angles by selecting either a Rotate Right icon 784 or a Rotate Left icon 786. Icon 784 rotates three dimensional representation 782 to the right and icon 786 rotates three dimensional representation 782 to the left. An orientation arrow 788 is provided on window 780 to indicate the orientation at which the rendering 782 is being viewed. Each time one of icons 784, 786 is selected to change the orientation of rendering 782, arrow 788 changes its orientation. If the customer selects 4 Sides icon 684, either before or after creating the custom graphics design, and then selects 3D icon 774, the custom graphics will be “mirrored” on the box. After the customer finishes viewing rendering 782, the customer selects Done icon 790, which prompts server 102 to return the customer to window 772.

In an alternative embodiment, a 3D window, similar to window 780, has an Unfold icon that, when selected, causes the 3D rendering of the package with graphics thereon to be unfolded to a flat rendering of the package; a Fold icon that, when selected, causes the flat rendering of the package to be folded back up to form the 3D rendering of the package; a Step Fold icon that, when selected, causes the flat rendering of the package to fold up one fold at a time (i.e., step-by-step with each step occurring due to one click on the Step Fold icon); and a Step Unfold icon that, when selected, causes the 3D rendering of the package to unfold one fold at a time (i.e., step-by-step with each step occurring due to one click on the Step Unfold icon). In this alternative embodiment, a mouse cursor may be used to change the orientation of the rendering appearing on the customer's computer screen by clicking and dragging on the 3D window, regardless of the extent to which the rendering is folded or unfolded. Also in this alternative embodiment, the graphics appearing on the packaging materials are maintained on the rendering with the proper appearance and perspective as the rendering is folded, unfolded, and reoriented.

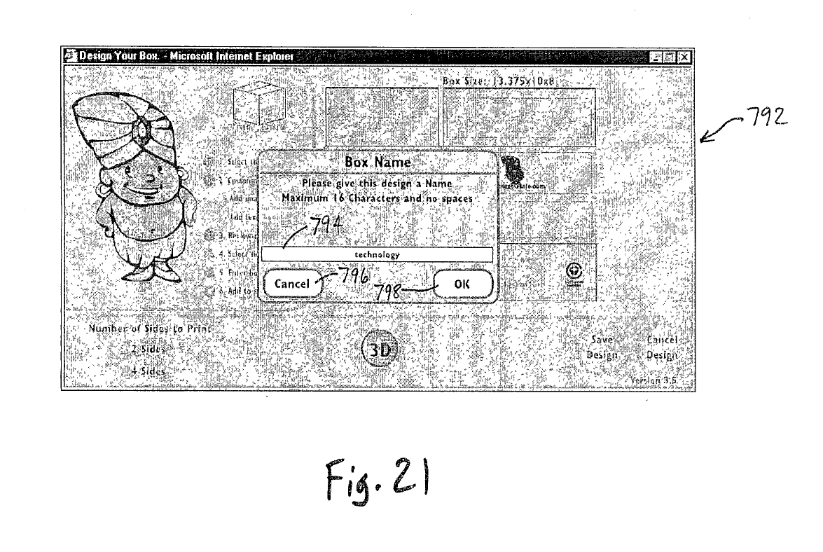

If the customer decides to save the custom graphics design, for use in an existing purchase during the customer's session on the website or for use in later purchases during future sessions on the website, the customer selects icon 776. After the customer selects icon 776, server 102 responds with a Box Name window 792 as shown in FIG. 21. Window 792 has a Box Name dialog box 794 in which the customer types the name of the custom graphics design, a Cancel icon 796, and an OK icon 798. If the customer selects icon 796 either before or after entering text in box 794, server 102 returns the customer to window 772, shown, for example, in FIG. 19. If the customer selects icon 798 after entering text in box 794, server 102 returns the customer to page 528, shown, for example, in FIG. 9. When customer selects icon 798 after entering text in box 794, server 102 stores the custom graphics design in the customer's individual folder of custom graphics designs. In the illustrative example, after the customer enters the name “technology” in box 794 and selects icon 798, the custom graphics design having image 731 and text block 768 is stored in a database table on web server 102.

After the customer selects icon 798 on web page 792 so that server 102 stores the custom graphics in memory and returns the customer to web page 528, the customer then has the option of selecting icon 666 so that the drop down menu of existing designs appears on the customer's computer screen with the newly created design included on the drop down menu. In this illustrative example, the design “technology” is included on the drop down menu associated with icon 666. If the customer decides to buy boxes with this design, the customer first selects the design from the drop down menu so that the name of the design, such as “technology” appears in box 664, and then, the customer selects Buy icon 660. After the user selects icon 660, server 102 responds with Cart page 540, as shown, for example, in FIG. 22.

Cart page 540 includes a table 800 that displays order data relating to each item of the current order. Table 800 has a Quantity column 810 containing quantity data, a Name column 812 containing box size data and substrate type data, a Design Name column 814 containing the name of the design to be printed on the packages, a Unit Price column 816 containing unit price data, a Total Price column 818 containing total price data, and a “Remove from Order” column 820. Table 800 also has an Individual Order row 822 and an Order Subtotal row 824. In the illustrative example, there is only one type of custom package being ordered, a 13.375×10×8 box having a kraft paper substrate and having the custom graphics named “technology” printed thereon.

Quantity column 810 has a dialog box 826 and an Update icon 828. The customer types, or otherwise enters (such as by voice), the desired quantity of packages to be ordered in box 826 and selects icon 828. After the customer enters quantity data in box 826 and selects icon 828, server 102 responds by updating the price appearing in column 818, row 822 of table 800 and the sub-total price appearing in column 818, row 824 of table 800. Server 102 calculates the individual price by multiplying the quantity of the item by the unit price of the item. In the illustrative example, the prices appearing in column 818 in rows 822, 824 are the same because only one item is being ordered. In those orders having multiple items, additional rows like row 822 appear in table 800 for the other items and the sub-total price is the sum of the individual prices of the various items being ordered.

In the illustrative embodiment, the sub-total price does not include shipping, handling, and, where applicable, sales tax. In other embodiments, some or all of these charges are included in the sub-total price. In one embodiment, system 100 is configured such that a minimum order value of one hundred dollars is required. In other embodiments, a different minimum order value, including no minimum order value, is required.

Table 800 has a Remove icon 830 in column 820, row 822 and a Remove All icon 832 in column 820, row 824 as shown in FIG. 22. If the customer selects icon 830, server 102 responds by removing from the order the item associated with row 822. If the customer selects icon 832, all items will be removed from the current order. Table 800 also has a Box Name icon 834 and a Design Name icon 836. If the customer selects icon 834, server 102 responds with page 528, an example of which is shown in FIG. 9, and the customer may then select various icons in page 528 in the manner described above. If the customer selects icon 836, server 102 responds with an Existing Box Design page 526, an example of which is shown in FIG. 24, and the customer may then select various icons. in page 526 as discussed below.

While viewing page 540, the customer has the option of either completing the order, by selecting a Check-Out icon 838, or adding additional items to the order, by selecting icon 624 in menu 610. If the customer selects icon 624 to add additional items to the order, server 102 responds with page 522a, an example of which is shown in FIG. 7, and the customer proceeds in the manner described above to select a desired box and to select or design desired graphics to be printed on the box. Any additional items that the customer adds to the order will be shown in table 800 on page 540 of FIG. 22. Thus, different boxes having different graphics may be included in the same order. Each item in an order is considered to be a “job” that is run on press 110. That is for each item in an order, press 110 will be configured in the appropriate way to run the size and type of box through press 110 and print heads 112 will be set up in the appropriate way to print the desired graphics on the boxes.

Page 522a has Upload Images icon 616 and View Existing Designs icon 618 as mentioned above. As also mentioned above, if the customer selects icon 616, server 102 responds with an Upload Images page 530, shown in FIG. 23, and if the customer selects View Existing Designs icon 618, server 102 responds with an Existing Box Design page 526, shown in FIG. 24. Page 530 has a dialog box 840 and a Browse button or icon 842. If the customer wants to upload an image from the customer's computer 128, the customer selects icon 842 and a “Choose file” pop-up window 844 will appear on the customer's computer screen as shown in FIG. 23. The window 844 is offset in FIG. 23 to avoid obstructing the view of the text on page 530.

After window 844 is opened, the customer selects a desired file from a directory 846 (or a sub-directory associated with an entry in directory 846) appearing in window 844. To gain access to a sub-directory of a particular entry in directory 846, the customer selects the entry in directory 846 by double-clicking on the selected entry, thereby causing the selected entry to appear in a Look In box 850 and causing the sub-directories in the selected entry to appear in the area of window 844 beneath box 850. Alternatively, the customer single clicks an entry in directory 846 and then selects an arrow icon 852 to cause a menu of sub-directories to appear on the customer's computer screen. If the file containing the desired image is several levels removed from directory 846, which is the “highest level” directory of the customer's computer, such as, for example, in a sub-directory of a sub-directory of directory 846, then the customer simply repeats the selection process just described.

When the desired file is selected, the name of the file appears in a File Name box 848 of window 844. The customer then selects an Open icon 854 of window 844 so that the file designated in box 848 appears in box 840 on page 530. If the customer decides not to upload any graphics to server 102, the customer selects a Cancel icon 856 of window 844. Alternatively, the customer may simply type the directory path to the file of the desired image in box 840, if the customer knows the directory path. It is within the scope of this disclosure for images to be selected in customer computer 128 for uploading to system 100 by any type of known file exploration program or file selection program.

After the customer adds to box 840 the file name of the image to be uploaded to server 102, the customer selects an Upload icon 858 on page 530 and the graphics from the selected file from the customer's computer is uploaded to server 102. In the illustrative embodiment of page 530, shown in FIG. 23, the customer is notified via text appearing on page 530 that the logo(s) (i.e. the graphics) uploaded by the customer will be converted to press ready format and will be available in folder 724, discussed above, in two business days and that there is a service charge of twenty five dollars per upload. In this embodiment, the customer is further notified of the following: the files to be uploaded should be files in either .gif, .tif, or .jpg format; the file size should not exceed two megabytes; the resolution of the graphics should be two hundred forty dots per inch or higher; the color of the graphics should be black; and the height of the graphics should not exceed four inches. In other embodiments, the uploaded images are converted by server 102 into press ready format either sooner or later than two business days, the upload charge is either more or less than twenty five dollars (including no upload charge), file formats other than or in addition to .gif, .tif, and .jpg are supported, the maximum file size that sever 102 will accept is more or less than two megabytes, the resolution of the graphics may be less than two hundred forty dots per inch, the color of the graphics may be other than black (including multi-colored), and the height of the graphics may be more than four inches.

If the customer selects icon 618 on any of the pages of the website on which icon 618 appears, server 102 responds with page 526 as shown, for example, in FIG. 24. Page 526 has a table 860 that lists all of the box designs that the customer has created in the past. Table 860 has a Design Name column 862 in which is listed the name the customer has assigned to each design created in the past, a Box column 864 in which is listed the size of each of the boxes associated with each of the designs created in the past, and a Design Date column 866 in which is listed the date on which each of the box designs were created in the past. Table 860 also has a Delete column 868 which includes, for each box design, a Delete icon 870; a View & Edit column 872 which includes, for each design, a View & Edit icon 874; and a Buy column 876 which includes, for each design, a Buy icon 878. A scroll bar 734 appears on page 526 if table 860 has more entries than are viewable on page 526 at one time.

If the customer selects one of icons 870 appearing on table 860, the associated box design is removed from table 860. If the customer selects one of icons 874 appearing on table 860, server 102 responds with page 772, similar to that shown in FIG. 19, but containing the graphics associated with the box design corresponding to the particular icon 874 selected. The customer then has the option of editing the selected box design in the manner described above. If the customer selects one of icons 878, the associated box design is added to table 800 on page 540 as one of the box designs to be included in the customer's order.

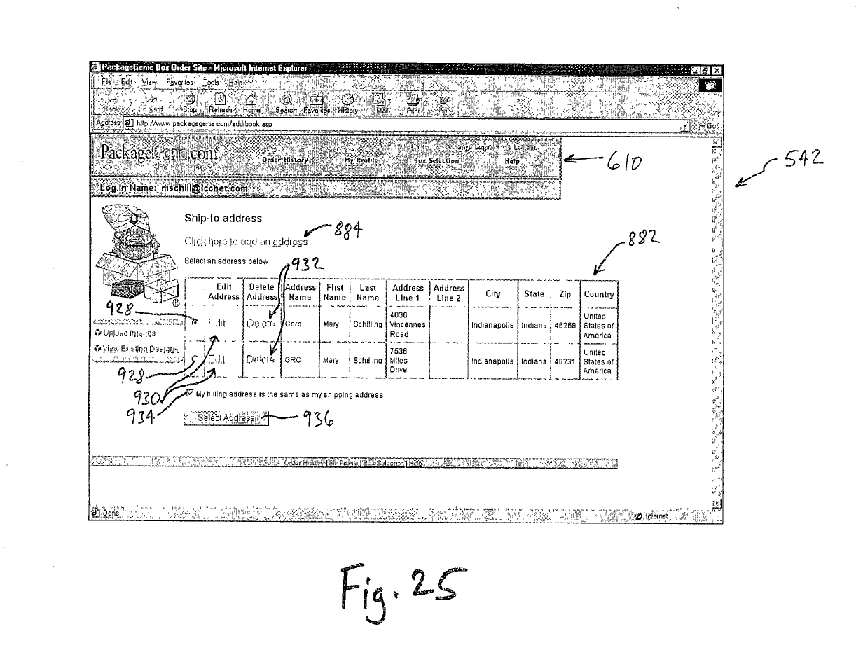

After the customer has created and/or selected all of the box designs that customer wants to order, such that all of the desired box designs appear in table 800 on page 540 of FIG. 22, the customer selects Check-Out icon 838 on page 540. When the customer selects icon 880, server 102 responds with a Ship-to Address page 542 as shown, for example, in FIG. 25. Page 542 has a table 882 that lists all of the Ship-to addresses to which the customer has had past orders shipped. If the customer is placing an order for the very first time or if the customer wants the existing order shipped to a new address, the customer selects a “Click here to add an address” icon 884.

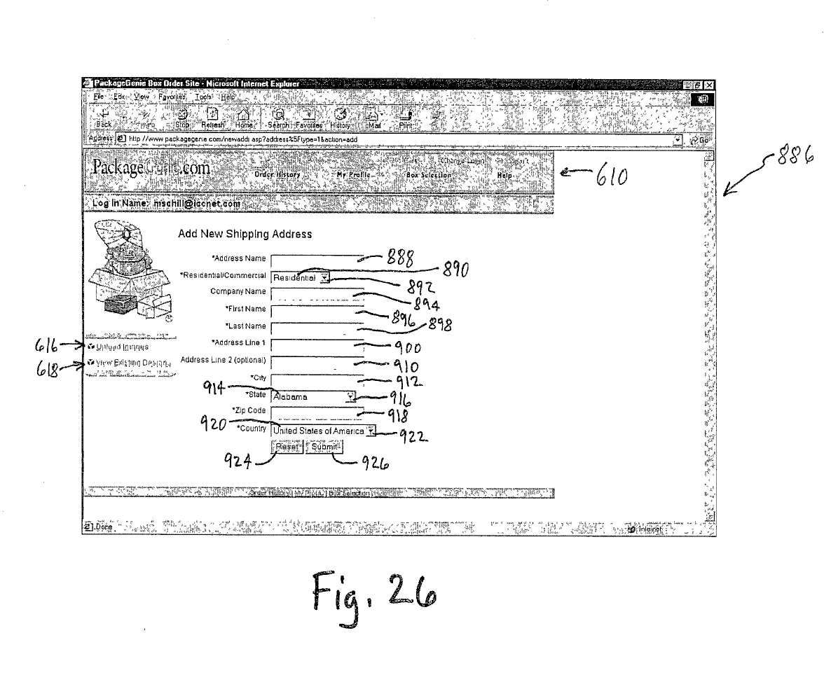

When the customer selects icon 884, server 102 responds with an Add New Shipping Address page 886, an example of which is shown in FIG. 26, if the customer is an existing customer or else server 102 responds with an Editing Profile page if the customer is a new customer. The Editing profile page was discussed above in connection with block 280 of FIG. 3B. Page 886 is configured to permit the customer to enter a-shipping address into system 100. Page 886 has an Address Name dialog box 888 in which the customer enters a descriptive name such as “home address” or “work address,” in order to make the address more identifiable to the customer. Page 886 has a Residential/Commercial dialog box 890 and an arrow icon 892 that the customer uses to select either “commercial” or “residential” from a drop down menu that appears on the customer's computer screen when icon 892 is selected, to identify whether the ship-to address is a commercial address or a residential address. Page 886 further has a Company Name dialog box 894 in which the customer enters the name of the customer's company, if desired; a First Name dialog box in which the customer enters the customer's first name; a Last Name dialog box 898 in which the customer enters the customer's last name; an Address Line 1 dialog box 900 in which the customer enters the first line of the ship-to address, such as the street address; an Address Line 2 dialog box 910 in which the customer enters, if applicable, the second line of the ship-to address, such as a suite number; a City dialog box 912 in which the customer enters the city of the ship-to address; a State dialog box 914 in which the customer enters the state of the ship-to address by selecting the state from a drop down menu which appears when an arrow icon 916 is selected; a Zip Code dialog box 918 in which the customer enters the zip code of the ship-to address; and a Country dialog box 920 in which the customer enters the country of the ship-to address by selecting the country from a drop down menu that appears when an arrow icon 922 is selected.

Page 886 has a Reset icon 924 and a Submit icon 926 as shown in FIG. 26. If the customer selects icon 924, all entries in dialog boxes 888, 890, 894, 896, 898, 900, 910, 912, 914, 918, 920 are returned to the entries that appeared in these dialog boxes when the customer first entered page 886. If the customer selects icon 926, the ship-to address is stored in memory of system 100 and server 102 responds with page 542 having the new ship-to address included in table 882.

As shown in FIG. 25, table 882 has columns that contain the following data: address name, first name, last name, address line 1, address line 2, city, state, zip code, and country data. Table 882 also has, for each address, a radio button 928, an Edit icon 930, and a Delete icon 932. If the customer selects icon 932, the associated address is deleted from table 882. If the customer selects icon 930, server 102 responds with page 886 having the selected address data already entered into dialog boxes 888, 890, 894, 896, 898, 900, 910, 912, 914, 918, 920 and the customer has the option of modifying the information appearing in any of dialog boxes 888, 890, 894, 896, 898, 900, 910, 912, 914, 918, 920. The customer designates the address to which the existing order is to be shipped by selecting the associated radio button 928. When one of radio buttons 928 is selected, the other radio buttons are deselected automatically.

Page 542 has a check box 934 that, when selected, indicates that the customer's billing address is the same as the customer's shipping address. A check mark appears in box 934 when box 934 is selected. When box 934 is deselected, the check mark disappears from box 934 and server 102 responds with a Billing Address page (not shown) that is substantially the same as page 886 so that the customer is able to enter appropriate billing address information. As shown in the illustrative example, the “Corp” address in the upper row of table 882 has been selected with the corresponding radio button 928 and box 934 is checked to indicate that the billing address is the same as the shipping address. As discussed below in more detail, custom package printing orders are paid by credit card in the illustrative example. Thus, in such an embodiment it is not necessary to send a separate bill to the customer. In alternative embodiments, customer's are billed separately and, in such embodiments, a billing address is needed.

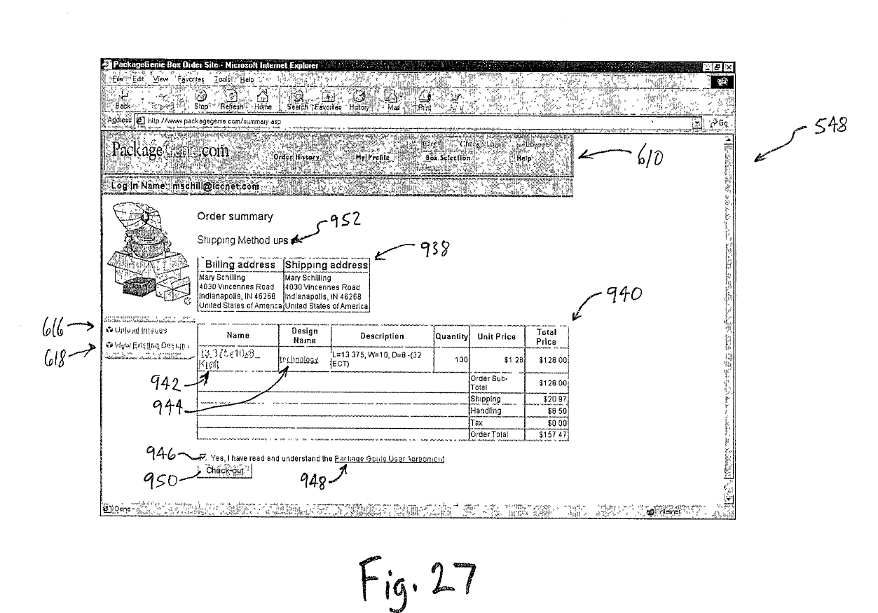

Page 542 has a Select Address icon 936 as shown in FIG. 25. After the customer has selected the desired ship-to address by clicking the appropriate radio button 928, the customer selects icon 936 and server 102 responds with Order Summary page 548 as shown, for example, in FIG. 27. Page 548 has a first table 938, which shows the shipping address and the billing address associated with the order, and a second table 940 which shows a line-by-line description of each item in the order, and also the order subtotal cost, the shipping cost, the handling cost, the tax, if any, and the order total cost. Table 940 has a Box Name icon 942 and a Design Name icon 944. If the customer selects icon 942, server 102 responds with page 528, an example of which is shown in FIG. 9, and the customer may then select various icons in page 528 in the manner described above. If the customer selects icon 944, server 102 responds with an Existing Box Design page 526, an example of which is shown in FIG. 24, and the customer may then select various icons in page 526 as also described above.

In the illustrative example, page 548 has a line of text 952 indicating that, when the order is ready for shipment to the customer, the designated shipping carrier that will deliver the order to the customer is United Parcel Service (UPS). In alternative embodiments, page 548 includes a Shipping Method icon that, when selected, permits the customer to select the shipping method (including shipping carrier, such as U.S. Postal Service, UPS, Federal Express, and the like, as well as the priority of shipment, such as overnight, two-day, regular mail, and the like) from a variety of shipping method options that are presented to the customer. It is within the scope of this disclosure for the costs associated with shipping the order via the various shipping carriers with the various types of priority to also be presented to the customer so that the customer is able to base the customer's shipping decision on shipping cost, if desired.

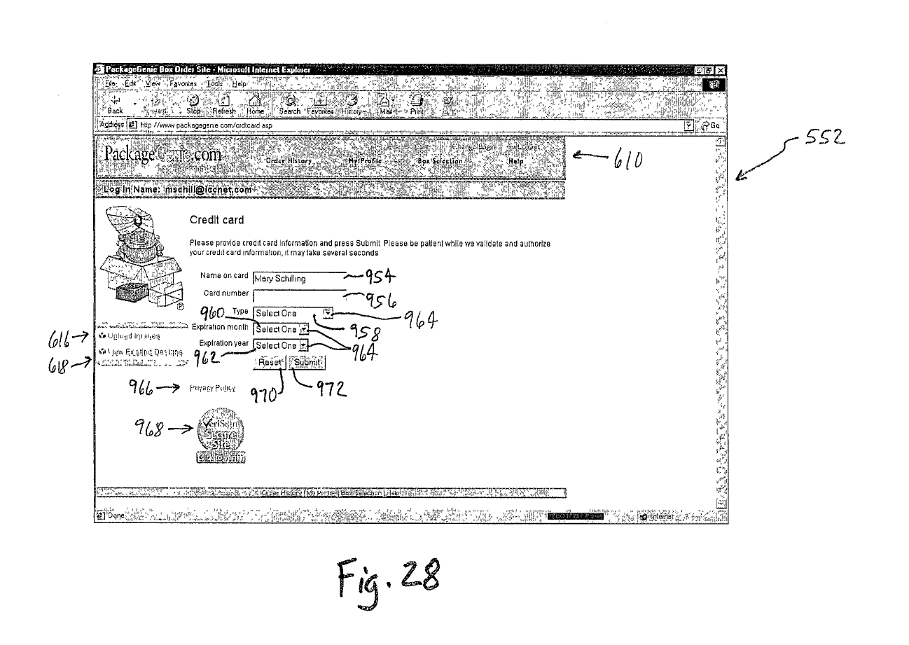

Page 548 further includes a check box 946 that is checked if the customer has read and understood a user agreement associated with the website. If the customer has not read the user agreement, or if the customer wants to review the user agreement again, the customer selects a User Agreement icon 948 of page 548 and server 102 responds with a pop-up window which displays the user agreement having all of the text of the terms of service for use of system 100. Page 548 has a Check-Out icon 950 that the customer selects if the customer wishes to complete the order. If the customer has not activated check box 946 to indicate that the customer has read and understood the user agreement prior to selecting icon 950, then when the customer selects icon 950, server 102 responds with a pop-up box requesting that the user read the terms of service. However, if the user has activated check box 946, then when the customer selects icon 950 server 102 responds with a Credit Card page 552, an example of which is shown in FIG. 28.

Credit card page 552 has a “Name on Card” dialog box 954, a Card Number dialog box 956, a Type dialog box 958, an Expiration Month dialog box 960, and an Expiration Year dialog box 962. The customer enters into box 956 his or her name and enters into box 958 the credit number of the credit card with which the customer is going to pay for the order. Each of boxes 958, 960, 962 has an associated arrow icon 964 that, when selected, causes an associated drop down menu of available options to be presented to the user. For example, when icon 964 associated with box 958 is selected, the corresponding drop down menu lists the types of credit cards that system 100 will accept for payment. In one embodiment, the types of credit cards that are acceptable for paying for orders are American Express, Discover, Master Card, and Visa. It is within the scope of this disclosure for system 100 to be configured to accept payment via any type of credit card or debit card or any other similar type of electronic payment. When icon 964 associated with box 960 is selected, the corresponding drop down menu lists the months of the year (i.e. January, February, March, . . . , December) and when icon 964 associated with box 962 is selected, the current year and a certain number of subsequent years are listed. The customer selects from the drop down menus associated with boxes 958, 960, 962 the card type, the expiration month, and the expiration year, respectively.

Page 552 has a Privacy Policy icon 966 and a Secure Site icon 968 as shown in FIG. 28. If the customer selects icon 966, server 102 responds with one or more pages of text containing the entire privacy policy regarding how the company hosting the website uses personal data. If the customer selects icon 968, server 102 links the customer to a third party provider, such as, for example, VeriSign, Inc., to provide the customer with data about the security of the custom package-printing website. As part of providing the customer with assurance that the website is secure, the third party provider may explain that data obtained from the customer via the website is encrypted and that the website is hosted by a reputable organization approved by the third party provider.

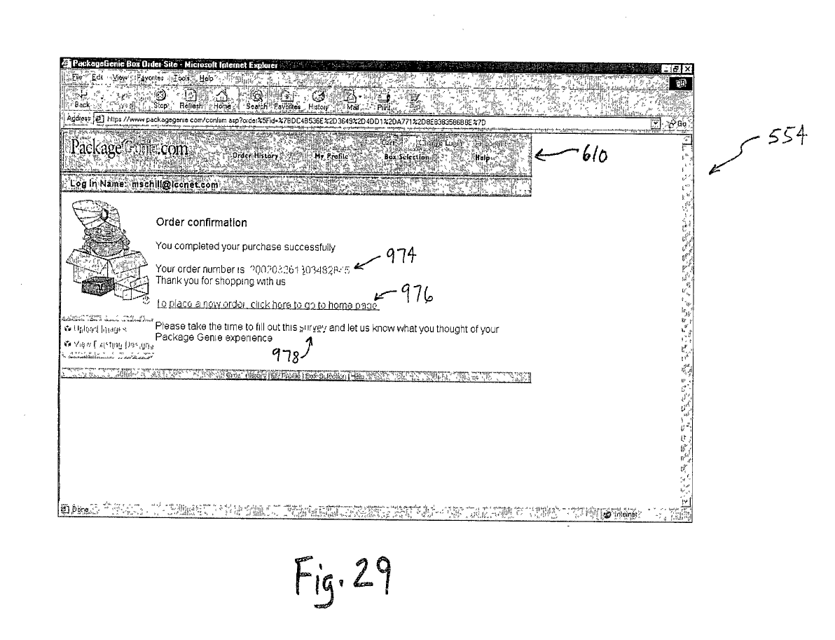

Page 552 has a Reset icon 970 and a Submit icon 972. If the customer selects icon 970, server 102 responds by deleting all changes made in boxes 954, 956, 958, 960, 962 and resetting these boxes back to the original values. If the customer selects icon 972, server 102 responds with an Order Confirmation page 554 as shown, for example, in FIG. 29. Submitting valid credit card information by selecting icon 972 after entering the appropriate data in boxes 954, 956, 958, 960, 962 ends the order placement process. During the process of validating the customer's credit card information, server 102 links to the appropriate credit card company (payment processor 130, in the illustrative example) to confirm that the customer's credit card is valid and to notify the credit card company that the customer has purchased merchandise of a certain price.

Page 554 includes text that notifies the customer that the order has been successfully placed and also notifies the customer of the order number assigned by system 100 to the order. In the illustrative embodiment, the order number corresponds to the year (first four digits of the order number), the month (next two digits of the order number), the day (next to digits of the order number), and the time (next ten digits of the order number). The “time” portion of the order number includes, in twenty-four hour format, the hour, minute, and second (down to ten thousandths of a second) corresponding to the time at which the order was placed. This method of order number assignment virtually assures that no two order numbers in system 100 will be identical.

Page 554 has an Order Number icon 974, a “To place a new order, click here to go to home page” icon 976, and a survey icon 978 as shown in FIG. 29. If the customer selects icon 978, server 102 responds with a survey (not shown) that the customer has the option of filling out to provide feedback regarding the customer's experience using the website to place a custom package-printing order. If the customer selects icon 976, server 102 responds with page 522a and the customer proceeds from page 522a in the manner described above. If the customer selects icon 974, server 102 responds with an Order Details page 980 that contains details about the customer order associated with icon 974. In the illustrative example, page 980 lists the order number, order date, sub total, shipping charge, handling charge, sales tax (if applicable), total charge, payment method, and billing address identifier. Page 980 also lists the line items (i.e. jobs) of the order including, for each line item, the box name, box description, quantity, -shipping method, shipping address identifier, and line item total. Page 980 further lists any shipping and billing addresses associated with the order. Page 980 has a Close icon 982 that, when selected, prompts server 102 to return the customer to page 554.

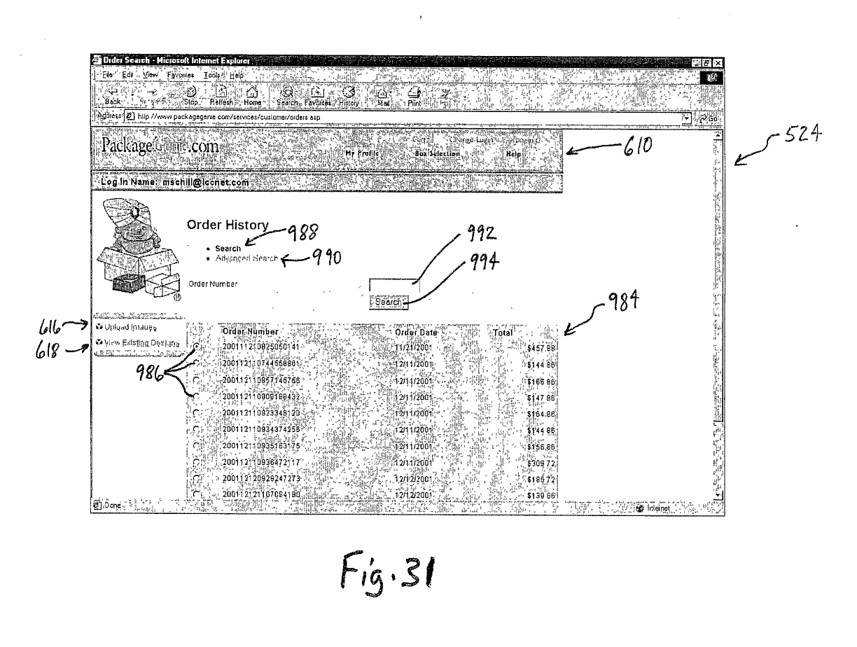

Many of the pages of the website described above include Order History icon 620. If the customer selects icon 620 on any of the pages on which icon 620 is active, server 102 responds with an Order History page 524 as shown, for example, in FIG. 31. Page 524 has a table 984 that lists all of the order numbers of the customer's past orders, the order data associated with each of the customer's past orders, and the total cost of each of the customer's past orders. In alternative embodiments, any of the other types of order data described herein are included on table 984. Page 524 also has a plurality of radio buttons 986, each of which is adjacent a respective order listed on table 984. Selecting any one of radio buttons 986 automatically deselects all of the other radio buttons 986. When the customer selects one of buttons 986, server 102 responds with page 980 including the order details of the order associated with the selected button 986.

Page 524 further includes a Search icon 988 and an Advanced Search icon 990. If the customer selects icon 988, server 102 responds with a dialog box 992 and a Search button 994 on page 980 as shown in FIG. 31. If the customer types into dialog box 992 an order number and then selects button 994, server 102 searches its database or associated databases for the order corresponding to the order number entered into box 992. If server 102 finds the order being searched, then server 102 shows the order in table 984 so that the customer is able to select the associated button 986 to see the order details of the corresponding order. If the customer selects icon 990, server 102 responds with a dialog box (not shown) that is similar to box 992 and a search button (not shown) that is similar to button 994. Using the advanced search feature of the website associated with icon 990, after the customer types text or other search strings into the associated dialog box and selects the companion search button, server 102 searches its database or associated databases for orders containing the text or string being searched. Orders having the text or string being searched are shown on table 984. The customer then has the option of selecting the associated button 986 of the orders uncovered in the advanced search to see the order details of the corresponding order.

During the order placement process described above, order data 996 is stored in one or more memory devices or databases associated with web server 102 as shown diagrammatically in FIG. 32. Order data 996 includes any of the data provided by the customer to system 100 as described above. Thus, order data 996 includes package data 998, graphics data 1000, print data 1010, price and quantity data 1012, address data 1014, and payment data 1016. Package data 998 includes, for example, the size and type of packaging ordered by the customer and the type of substrate of the packaging. Graphics data 1000 includes, for example, the images and text that the customer wants to have printed on the packaging materials. Print data 1010 includes, for example, the area on the packaging materials where the graphics are to be printed. Price and quantity data 1012 includes, for example, the unit price of the packages ordered by the customer, the total price of the packages ordered by the customer, and the number of packages ordered by the customer. Address data 1014 includes, for example, the ship-to address and the billing address. Payment data 1016 includes, for example, the type of credit card the customer used to pay for the order, the credit card number, and the expiration date of the credit card.

As the order data is being entered into system 100 by the customer, server 102 creates various data files once the appropriate data needed to create the particular files is known. For example, once the customer selects the size and type of box to be ordered, a sequel table is created by server 102 with various information that is used to configure press 110. Such information includes the thickness of the box and the width of the box in its knock-down configuration. Based on such information, the positions of various portions of press 110, such as a print caliper that controls the height of print heads 112, a coater caliper that controls the nip of coater 126, and a board size that controls the configuration of feeder, is established. After the customer pays for an uploaded image, a program is run on server 102 that creates a .bmp file, a .swf file, and a .png file and that adds the .bmp file to the customer's individualized folder 724. The .bmp file is later processed into the image that actually get printed on the packaging materials. The .swf file contains the image that is displayed on the flash design pages 538 as shown, for example, in FIGS. 10, 11, and 16-19. The .png file contains the images that are displayed in 3D window 780 on rendering 782 as shown, for example, in FIG. 20.

If the customer pays for a custom image upload to system 100 as part of the custom design process, server 102 tags the uploaded image with an identifier and places the uploaded image in a new directory which is labeled by the customer's user name and which is contained in a purchased images directory. In one embodiment of system 100, a system administrator periodically checks the purchased image directory for new images and modifies the images, if appropriate, into final form for storage in the customer's individualized folder 724 that is associated with the customer's e-mail address. Modifications that the system administrator has the option of making include, for example, adjusting the dither pattern or changing the resolution of the image to 240 dots-per-inch. In alternative embodiments, any modifications that are needed to ready uploaded images for print production are made automatically by server 102 or any other computer device included in system 100.

As indicated diagrammatically in FIG. 32 at block 1018, server 102 tags incoming customer orders with an order number and a new order identifier. New orders are stored by server 102 in an Orders Directory or folder 1020, which is one of the high level directories of server 102. Orders Directory 1020 contains separate order folders (i.e. sub-directories) for all of the incoming orders, with each order folder having the particular order number as its file name. Within each order folder of Orders Directory 1020 is a Jobs Directory or folder 1022 that contains all of the files created by server 102 for each job associated with an order. Each Jobs folder 1022 contains an X.set file 1024, an X.ijq file 1026, an X.cfg file 1028, a SETUP.cfg file 1030, a Bitmap Directory 1032, an X.xml file 1034, an X_O.xml file 1036, and either an X_EOJ.txt file or an X_EOJ.txb file 1038 as shown in FIG. 32. The “X” portion of each of the file names in the preceding sentence is a number assigned by server 102, such as, for example, an integer indicating the number in the sequence of the total number of jobs received by system 100.

The X.set file 1024 is a file created by server 102 and sent to printque server 104 to notify printque server 104 that a new order has been received by server 102 and to activate scheduler software 1040. The X.ijq file 1026 contains data relating to the size of the box and the ink color of print heads 112. The Bitmap Directory 1032 contains the bitmap (.bmp) files of the images that are to be printed on the boxes ordered by the customer. The X.cfg file 1028 contains the paths to the location of the graphics files in the Bitmap Directory 1032 and also contains information regarding the details of controllers, rips, and print heads 112 that will print the various images, the amount of random access memory of each of the print heads 112, the dimensions of the graphics to be printed, the X and Y coordinates of the graphics in the print area on the box, and other information relating to the print heads 112. The SETUP.cfg file 1030 is a duplicate of the X.cfg file but with additional header information that notifies a data merge engine of server 104 that a new order needs to be processed.

The X.xml file 1034 is a machine readable file and contains the instructions that are processed by computer 106 and controller 108 to configure press 110 to run the associated job. The X_O.xml file 1036 is a machine readable file that communicates to press 110 the number of sides to be printed, the priority for printing the order, the quantity to print, the bundle count, and whether or not the job has been run. The X_O.xml file is viewed by the press operator on the computer screen of controller 108 when the operator is preparing for and running the associated job on press 110. The X_EOJ.txt file 1038, or alternatively the X_EOJ.txb file 1038, is a human readable file that is printed out as a document and shipped to the customer along with the packaging materials ordered by the customer. The document printed from file 1038 contains text that thanks the customer for the order and also contains information such as the order number, the shipping method, the ship-to address and order details, such as box type, quantity, and pricing. If custom graphics are printed on the packaging materials, then server 102 creates the X_EOJ.txt file. If plain boxes (i.e. those without custom graphics, including pre-printed boxes) are ordered by the customer, then server 102 creates the X_EOJ.txb file. When the press operator retrieves a job, if the press operator sees that an X_EOJ.txb file has been created, instead of an X_EOJ.txt, the operator then knows that the order does not require the packaging materials to be run through press 110.

Files 1024, 1026, 1028, 1030, 1034, 1036, 1038 and the files in Bitmap Directory 1032 that are associated with each order received by server 102 are transferred periodically from server 102 to server 104. The scheduler software 1040 of server 104 controls various data conversion operations of server 104. For example, scheduler software 1040 is configured to provide instructions to data merge software of server 104 to initiate a conversion of the X.cfg file 1028 to an X.ijp file 1042. Thereafter, scheduler software 1040 provides instructions to compression software of server 104 to initiate a conversion of the X.ijp file 1042 to an X.zip file 1044. In addition, scheduler software 1040 provides instructions to proofer software of server 104 to convert the X.ijp file 1042 to an X.ps (post-script) file 1046, and then scheduler software 1040 provides instructions to distiller software of server 104 to convert the X.ps file 1046 to an X.pdf file.

After server 104 has created the X.zip file 1044 (which contains the X.ijp file in a compressed or “zipped” format) and the X.pdf file, an operator retrieves files 1034, 1036, 1038, 1044, 1048 from server 104 and copies them to the hard drive of computer 105. After files 1034, 1036, 1038, 1044, 1048 are retrieved by the operator, the operator launches the press software on computer 105 which allows the X.xml file 1034, the X_O.xml file 1036, and X.pdf file 1048 to be viewed on the screen of controller 108. File 1038 is printed out from computer 105 and given to the operator or other support staff. If desired, the operator previews on the computer screen of controller 108 the graphics to be printed on the packaging materials by opening the X.pdf file 1048.

Controller 108 retrieves the X.zip file 1044 from computer 105, unzips it to recreate the X.ijp file 1042, and sends the X.ijp file 1042 to computer 106. Based on the data in the X.ijp file 1042, computer 106 communicates graphics data to print heads 112 to run the associated job. In addition, based on the data in the X.xml file 1034, controller 108 physically configures press 110 to run the associated job. The operator is able to override the automatic setup of press 110, if desired, using controller 108. After the operator loads the appropriate type and quantity of materials onto staging area 124 of press 110, the operator enters the appropriate commands, such as by selecting a “print” icon (not shown), on computer 106 or controller 108 to run the job on press 110. After the job is run, the operator or one or more co-workers attend to shipping the completed order to the customer. In those embodiments of system 100 in which the customer does not pay for the customer's order by credit card, a separate billing statement is sent to customer to bill the customer for the order. In alternative embodiments, packaging materials are loaded onto staging area 124 of press 110 and/or are removed from press 110 robotically.

It is within the scope of this disclosure to include a “variable print” step in the custom box-printing process to enable customers to vary artwork on boxes in an order on a box-by-box basis. In such embodiments, the website includes a “variable data” page that permits the customer to enter variable text and/or images into a spread sheet or table. In addition for each graphic of the multiple graphics included in the table of variable data the customer is able to designate the quantity of boxes to be printed with the particular graphics. Thus, in this embodiment, the customer is able to elect to vary text and images printed on each individual box or on a plurality of boxes associated with the order in any sequence or according to any specification defined by the customer. Such variable data is useful, for example, if the customer wants to vary the text appearing in a particular field from box-to-box.

Although the Internet-based custom package-printing process has been described in detail with reference to a certain illustrative embodiment, variations and modification exist within the scope and spirit of the disclosure as described and defined in the following claims.

1. A method of producing packages with custom images printed on the packages, the method comprising
hosting a website configured for entry of custom printing orders by customers,
receiving a custom printing order via the website from a customer, the custom printing order including package data indicative of a package type desired by the customer, quantity data indicative of a quantity of packages desired by the customer, and image data indicative of an image to be printed on the packages,
processing the custom printing order received via the website and transmitting the image data to a controller configured to control print heads of a printing machine that is operable to print images on packages,
loading the quantity and type of packages ordered by the customer onto a transport portion of the printing machine, and
operating the printing machine so that the printer heads automatically print on each package the image indicated by the image data.

2. The method of claim 1, wherein hosting a website comprises hosting a website having a package-size web page that displays a plurality of package-size icons that are selectable by the customer to indicate a size of the packages desired by the customer.

3. The method of claim 2, wherein the packages comprise boxes and the package-size icons comprise numbers indicating the approximate lengths of boxes of different sizes.

4. The method of claim 3, wherein hosting a website comprises hosting a web site having a second package-size web page that, after selection by the customer of one of the numbers indicative of the approximate length of the boxes desired by the customer, displays a list of width and height options for boxes having the approximate length selected by the customer.

5. The method of claim 2, wherein hosting a website comprises hosting a website having a web page that displays a price per package and the price per package is based on the size of the packages desired by the customer.

6. The method of claim 1, wherein hosting a website comprises hosting a website having a series of web pages on which the customer enters the printing data.

7. The method of claim 6, wherein at least one of the series of web pages has an icon that, when selected, displays a list indicative of printing data associated with orders placed by the customer in the past.

8. The method of claim 6, wherein at least one of the series of web pages has an icon that, when selected, links the customer to at least one upload web page configured to permit the customer to upload from a customer computer file the image to be printed on the packages.

9. The method of claim 6, wherein at least one of the series of web pages has an icon that, when selected, links the customer to an art library having a plurality of graphical images that are selectable by the customer to comprise at least a part of the printing data.

10. The method of claim 6, wherein the image data includes text that the customer desires to have printed on the packages and at least one of the series of web pages is configured to permit the customer to enter the text to be printed on the packages.

11. The method of claim 1, wherein hosting a website comprises hosting a website having a web page that displays a graphical rendering of the package type desired by the customer and that has a plurality of fields on the graphical rendering, at least one field of the plurality of fields being selectable by the customer to indicate the location on the packages where the image is to be printed.

12. The method of claim 11, wherein the package type is a box and the graphical rendering is a graphical image of the box in a knock-down configuration.

13. The method of claim 12, wherein the plurality of fields comprise at least one field on each of a top flap, a side wall, and an end wall of the box.

14. The method of claim 12, wherein hosting a website comprises hosting a website having a web page with an icon that, when selected, creates a three-dimensional rendering of the box and the image is shown on the three-dimensional rendering in the at least one field selected by the customer.

15. The method of claim 1, wherein receiving a custom printing order comprises receiving location data indicative of a location on the packages where the image is to be printed.

16. The method of claim 1, further comprising storing the image data in a memory device so that the image data is cataloged for retrieval by the customer when placing future orders.

17. A method of producing packages with custom images printed on the packages, the method comprising
hosting a website configured to permit a customer to upload an image to be printed on the packages,
receiving via the website an uploaded image from the customer, and
printing the uploaded image on the packages.

18. The method of claim 17, wherein hosting a website comprises hosting a website having at least one web page on which the customer selects from a variety of package size options a size of the packages on which the image is to be printed.

19. The method of claim 17, wherein hosting a website comprises hosting a website having a web page that displays a graphical rendering of the package desired by the customer and that has a plurality of fields on the graphical rendering, at least one field of the plurality of fields being selectable by the customer to indicate the location on the packages where the uploaded image is to be printed.

20. The method of claim 19, wherein the packages comprise boxes and the graphical rendering is a graphical image of one of the boxes in a knock-down configuration.

21. The method of claim 17, wherein hosting a website comprises hosting a website having a web page with an icon that, when selected, creates a three-dimensional rendering of the box and the uploaded image is shown on the three-dimensional rendering.

22. The method of claim 17, further comprising storing the uploaded image in a memory device so that the uploaded image is cataloged for retrieval by the customer when placing future orders.

23. A method of printing images on packaging materials, the method comprising
receiving via a website a customer order for packaging materials having custom graphics printed on the packaging materials,
processing the customer order via a computer into machine-readable instructions and human-readable instructions for processing the packaging materials,
communicating the machine-readable instructions to a printing press to configure the printing press for printing the custom graphics on the packaging materials, and
operating the printing press to print custom images on the packaging materials.

24. The method of claim 23, wherein prior to operating the printing press, an operator of the printing press reads the human-readable instructions on a computer screen of a computer that the operator uses to operate the printing press.
